(19) United States
(12) Patent Application Publication
(10) Pub. No.: US 2017/0032400 A1
(43) Pub. Date: Feb. 2, 2017

(54) VEHICLE DATA SYSTEM FOR DISTRIBUTION OF VEHICLE DATA IN AN ONLINE NETWORKED ENVIRONMENT

(71) Applicant: TrueCar, Inc., Santa Monica, CA (US)

(72) Inventors: Rudy C. Gilmore, Pasadena, CA (US); Emily R. Dunkel, Encino, CA (US); Michael D. Swinson, Santa Monica, CA (US)

(21) Appl. No.: 15/220,168

(22) Filed: Jul. 26, 2016

Related U.S. Application Data
(60) Provisional application No. 62/197,274, filed on Jul. 27, 2015.

(51) Int. Cl. G06Q 30/02

(52) U.S. Cl. CPC G06Q 30/0206; G06Q 30/0201

(57) ABSTRACT

A vehicle data system having improved performance is described. In particular, embodiments provide system and methods for vehicle data systems that can both accurately predict marketing trends and presenting those accurate marketing trend predictions in real-time over a computer network. These capabilities, among others, may be accomplished by embodiments of vehicle data systems disclosed herein through the use of a bifurcated architecture by which a significant amount of detailed processing is accomplished in a back-end process, including the gathering and binning of data and the use of such data to determine parameters for models or adjustment components that may be used to accurately forecast market trends for new and used vehicles. In a front-end process, requests for such market trend forecasts for specified vehicles or locations may be received over a network. Enabled by the data, models or adjustment components determined in the back-end, an accurate market trend forecast may be determined and an interface with the forecast market trend returned to the user in real-time over the network.

### RELATED APPLICATIONS

This application claims the benefit of priority under 35 U.S.C. §119 to provisional patent application No. 62/197,274 filed Jul. 27, 2015 entitled “Market Pricing Trend Prediction System and Method,” the entire contents of which are hereby expressly incorporated by reference for all purposes.

### COPYRIGHT NOTICE

A portion of the disclosure of this patent document contains material that is subject to copyright protection. The copyright owner has no objection to facsimile reproduction of the patent document or the patent disclosure as it appears in the Patent and Trademark Office patent file or records, but otherwise reserves all copyright rights thereto.

### TECHNICAL FIELD

This disclosure relates generally to vehicle data systems. More particularly, this disclosure generally relates to systems and methods for vehicle data systems configured for use in an online distributed networked environment and the distribution of accurate vehicle data in real-time through such networked environments. Specifically, embodiments as disclosed relate to the accurate determination and real-time distribution of vehicle pricing and forecasts related to vehicle transactions through an online network, including forecasts of future vehicle pricing or price trends for both new and used vehicles.

### BACKGROUND

Currently, there are a number of online vehicle data systems that attempt to distribute certain vehicle data, including vehicle pricing data to users over an online network (e.g., Internet, cellular network, etc.). The current state of these vehicle data systems is, however, inadequate for the current demands of their users. These inadequacies stem from a number of deficiencies that can be grouped at a high level into two interrelated categories: the ability to both 1) distribute vehicle data in real-time over such online networks (i.e., at a speed at which a user of those online networks would expect a response under typical conditions), and 2) ensure that the vehicle data so distributed is accurate enough to meet those users' demands. So far, vehicle data systems have been forced (at least by ever-increasing user expectations regarding the speed of such online networks) to attend solely to the first concern. Namely, ensuring that any vehicle data provided can be provided at a speed which may meet the expectations of users of such systems. These systems have therefore provided inaccurate vehicle pricing data, and in some cases, at least because of the speed and accuracy issues, have neglected to provide certain vehicle pricing data altogether.

A microcosm of these problems occurs with respect to vehicle data systems and vehicle pricing. A vehicle price, relative to a reference price, such as a Manufacturer's Suggested Retail Price (“MSRP”) at which vehicle transactions (e.g., sales and purchases of automobiles) are concluded varies in response to a variety of factors, such as make, model, geography, date, or the like. These fluctuations in price relative to a standard may create inefficiencies on both sides of automotive transactions, such as buyers purchasing on days on which sale prices are predicted to be higher and, on the other side, dealers overstaffing dealerships on days on which sale prices are expected to be lower than normal. It would be desirable, therefore, to be able to determine and present to users of online vehicle data systems data related to pricing trends, including both historical trends and predicted trends. The effects of the various factors discussed (among others) are, however, complex and interrelated and may be difficult to predict or capture. As a result, accurate and useful vehicle data related to these market trends is likewise difficult to determine in many instances, and in particular, in a time frame that would allow such data to be presented over an online network in real-time by vehicle data systems.

Accordingly, current systems cannot both accurately account for the complexity of automotive transactions and return such vehicle data, including marketing trend data, in a timeframe that users of online based vehicle system demand. Put differently, current systems may be incapable of considering the wide number of disparate variables affecting sale price that distinguish automotive transactions (e.g., vehicle trim, mileage, geography) from sales of more fungible commodities, such as airline tickets. Additionally, current systems lack the architecture and configuration to collect and analyze the complex data affecting the expected price of a vehicle and timely return historical or future predictions of expected price variation through a user interface provided in real-time over an online distributed computer network.

There are, therefore, a number of unmet desires when it comes to systems and methods for vehicle data systems and the use of those vehicle data systems in predicting pricing variations and trends for vehicle transactions.

### SUMMARY

To address these needs among others, and for other reasons, disclosed embodiments provide system and methods for vehicle data systems that can both accurately predict marketing trends and presenting those accurate marketing trend predictions in real-time over a computer network. These capabilities, among others, may be accomplished by embodiments of vehicle data systems disclosed herein through the use of a bi-furcated architecture by which a significant amount of detailed processing is accomplished in a back-end process, including the gathering and binning of data and the use of such data to determine parameters for models or adjustment components that may be used to accurately forecast market trends for new and used vehicles. In a front-end process, requests for such market trend forecasts for specified vehicles or locations may be received over a network. Enabled by the data, models or adjustment components determined in the back-end, an accurate market trend forecast may be determined and an interface with the forecast market trend returned to the user in real-time over the network.

The forecast market trend may include predicted price ratios for the specified vehicle for a future time period associated with a specified location (e.g., a Direct Marketing Area (DMA), region or state associate with the specified location) or nationally. In particular, in certain embodiments, a predicted price ratio for each day of the future time period may be predicted and this predicted price ratio may be used to adjust a transaction price (e.g., Manufacturer's Suggested Retail Price (MSRP), an Inventory Price, an Upfront Price, etc.) such that a forecast price for that day may be generated. The forecast price or the price ratio for each day of the future time period may be used to generate the interface, which may include, for example, a plot, curve, graph etc. of the forecast price, price ratio, average forecast price, etc. for each day of the future time period. For example, an average price ratio as a function of time may be displayed as a line plot in an interface returned to the user.

Embodiments of a vehicle data system may thus be accessed by a variety of users. For example, dealers can access the vehicle data system via a proprietary dealer portal on the Internet (e.g., a web tool referred to as “Sales Optimizer” hosted on a website operating independent of the dealers) or end consumers may access the vehicle data system through a website.

Generally, prediction of pricing changes can be done by statistical techniques such as autoregressive (AR) or autoregressive moving average (ARMA) models, which predict future values for a time series based on past entries. While these models can predict vehicle pricing on a timescale of a few days with moderate accuracy, in many cases, they cannot accurately predict vehicle pricing on a multi-week timescale. One reason is that these time-based statistical techniques (AR/ARMA models) utilize only end points in time and cannot account for the effect of exogenous (external) factors such as incentive changes, age of inventory, holidays, time of day, time of month, etc. that can affect dealer cost and therefore influence pricing behavior. AR/ARMA models also have difficulty accounting for irregular time-based events such as end of month discounts that do not occur at standard intervals.

To address these insufficiencies and obtain a more accurate prediction of future time period, embodiments disclosed herein may operate by utilizing particular information about historical pricing trends. First, a prediction module in the back-end of the vehicle data system may apply an autoregressive model used to predict expected fluctuations over a short timescale (e.g., historical records in the past two to three years). To predict longer-term trends, a linear regression model may be used to account for exogenous factors such as current incentives, freight fees, inventory age for a particular dealer or other factors. Such models may be trained based on historical data. Finally, correction or adjustment components may be used to apply correction factors based, for example the current day of the week and number of days remaining in the month, holidays, etc. to capture trends that show a strong weekly or monthly trend. Accordingly, embodiments of the vehicle data system disclosed herein may include a prediction module which implements a combination of at least three models: an AR model, a linear regression model, and one or more correction components.

In some embodiments, the vehicle data system may utilize a multimodal predictor, which can capture or otherwise incorporate a variety of effects that are capable of influencing vehicle pricing. On the other hand, the vehicle data system may be sufficiently general that it can be applicable across a variety of makes and market conditions. This can be important because there can be large differences between brands in pricing behavior; some are found to exhibit strong cyclical weekly and monthly price variations, and others little or none, while the effect of incentives can also be highly dissimilar between makes (e.g., market pricing trends for vehicles of a certain price range may vary less from week to week/month to month relative to vehicles of a different price range). The flexibility of the vehicle data system gives it a large advantage over more traditional statistical methods, such as relying solely on autoregressive coefficients or external parameters.

In one embodiment, a vehicle data system for providing accurate vehicle data in real-time over a computer network may include a data store and a plurality of computing devices coupled to user computing devices and online data sources, over a network. A first computer device of the vehicle data system performs a back-end process including obtaining historical transaction data on a plurality of vehicles from the plurality of online data sources and segmenting the historical transaction data into a plurality of bins based on vehicle configuration, location and time. The front-end process may further determine a price ratio for each of the plurality of bins based on the historical transaction data in that bin and determine a predictor for each of the plurality of bins based on the price ratio determined for that bin and the historical transaction data associated with that bin, where the predictor includes a predictive price ratio model and one or more adjustment components.

A second computer device of the vehicle data system performs a front-end process operating distinctly from the back-end process to respond to requests received over the network via an interface module using the predictor and the plurality of bins of historical transaction data determined in the back in process. This real-time response may be accomplished after receiving a request for a prediction of a future market price of a vehicle where the request specifying a vehicle configuration, a location and a future time period. Based on the request the front-end process may identify a bin of historical data determined by the front-end process based on the specified vehicle configuration and location, obtain the historical data associated with the identified bin from the data store and obtain the predictor and one or more adjustment components for the identified bin determined by the front-end process. Using the predictor the front-end process may determine a predicted price ratio for the specified future time period based on the predictive price ratio model associated with the identified bin and adjust the predicted price ratio using the one or more adjustment components of the predictor associated with the identified bin. Using the predicted price ratio the front-end process can generate an interface providing a visual representation of a predicted market price over the specified time period based on the adjusted predicted price ratio, and respond to the request in real-time over the network by distributing the generated interface over the network via the interface module. The predicted market price may be a price ratio, a transaction price, an upfront price or another price.

In certain embodiments, the vehicle data system is configured to limit the magnitude of the adjustment by the one or more adjustment components using one or more guardrail values.

The set of bins may be ordered according to one or more parameters and identifying the bin comprises selecting a most specific bin with a threshold amount of historical transaction data.

In certain embodiments, the interface with the predicted market trend comprises a localized curve based on the predicted price ratio associated with the specified location as a function of the time period. The predicted price ratio can pertain to the Designated Market Area (DMA), region or state associated with the specified location. Alternatively or additionally, the interface may include a national curve based on the predicted price ratio associated with a nationwide location for the specified vehicle as a function of the time period.

As another embodiment, the interface may comprises a historical data curve including historical pricing data for the specified vehicle configuration over a past time period associated with the specified location, where the historical data curve was determined based on the historical transaction data associated with the identified bin.

According to certain embodiments, the adjustment components may include a first adjustment component configured to adjust the predicted price ratio on a historical derivation, a second adjustment component configured to adjust the predicted price ratio based on one or more exogenous parameter and a third adjustment component configured to adjust the predicted price ratio based on a status of a day. The at least one exogenous parameter may be a dealer incentive, a customer incentive, a transportation costs or advertising and while a status of a day may include a day of the week, a day of the month or a holiday.

Vehicle data systems as disclosed herein thus allow network clients (e.g., networked devices associated with dealers, consumers, original equipment manufacturers, auto finance captive companies, etc.) to access the system to obtain accurate market forecasts in real-time. Such data may be useful to purchasers, dealers or others in a vehicle ecosystem as it allows a better determination of both time frames for buying and selling and better determination of price levels, either when purchasing or setting prices. As compared with conventional approaches that provide far less accurate market trend predictions (and which typically cannot provide market predictions in real-time), representatively disclosed embodiments provide network clients with advanced and accurate market prediction tools that may be accessed and interacted with in real-time to provide useful data for among other things accurately pricing or purchasing vehicle assets.

These, and other, aspects of the disclosure will be better appreciated and understood when considered in conjunction with the following description and the accompanying drawings. It should be understood, however, that the following description, while indicating various representative embodiments of the disclosure and numerous specific details thereof, is given by way of illustration and not of limitation. Many substitutions, modifications, additions or rearrangements may be made within the scope of the disclosure without departing from the spirit thereof, and the disclosure contemplates and includes all such substitutions, modifications, additions or rearrangements.

### BRIEF DESCRIPTION OF THE DRAWINGS

The drawings accompanying and forming part of this specification are included to representatively depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 generally depicts a diagrammatic illustration of one embodiment of a vehicle data system.

FIGS. 2A and 2B depict one embodiment of a method for determining and presenting market price trend prediction.

FIG. 3 depicts one embodiment of an architecture for a vehicle data system.

FIGS. 4A and 4B depict one embodiment of the architecture and operation of a vehicle data system.

FIGS. 5A and 5B depict one embodiment for data binning for use in a vehicle data system.

FIG. 6 depicts one embodiment of applying aspects of corrections for use in a vehicle data system.

FIG. 7 depicts an overview of a workflow performed by one embodiment of a vehicle data system.

FIGS. 8A-8H provide graphs of data according to an example.

FIG. 9 depicts an embodiment of an interface of a vehicle data system.

### DETAILED DESCRIPTION

The invention and various features and advantageous details thereof are explained more fully with reference to the non-limiting embodiments that are representatively illustrated in the accompanying drawings and detailed in the following description. Descriptions of well-known starting materials, processing techniques, components and equipment are omitted so as not to obscure the invention in detail. It should be understood, however, that the detailed description and the specific examples, while indicating various representative embodiments of the invention, are given by way of illustration only and not by way of limitation. Various substitutions, modifications, additions or rearrangements within the spirit or scope of the underlying inventive concept will become apparent to those skilled in the art from this disclosure. Embodiments discussed herein may be implemented in suitable computer-executable instructions that may reside on a computer readable medium (e.g., a hard disk (HD)), hardware circuitry or the like, or any combination thereof. For example, though embodiments of the present invention have been presented using the example commodity of vehicles it should be understood that other embodiments may be equally effectively applied to other commodities.

As discussed above, automotive transactions are, from a forecasting view, difficult to model and predict, given the variety of factors which may cause the price to move above or below a reference price, and the non-fungible nature of the underlying commodity. In contrast to, for example, airline tickets, where differences in airlines do not typically matter to a pricing prediction, differences between, amongst other things, make, model, trim level, geographic location, etc. need to be considered in the automotive context. These difficulties are compounded for used cars, where additional parameters, such as mileage, need to be factored into the calculation. Similarly, forecasting automotive transaction prices may be complicated in cases where there is a shortage of historical sales from which to use statistical methods, such as immediately after the release of a new model year, or exotic, hard-to-find vehicles.

Additionally, the large number of permutations of variables (e.g., make, model, trim, geography, date, etc.) which need to be considered by a vehicle data system, mean that accurate market trends, including price forecasts, cannot be generated and presented in real-time over an online distributed computer network using typical methods employing solely the generic functionality of a computer.

Accordingly, current systems cannot both accurately account for the complexity of automotive transactions and return such vehicle data, including marketing trend data, in a timeframe that users of online based vehicle system demand. In the absence of a fast, accurate prior art system for predicting trends in the vehicle market there are a number of unmet desires when it comes to vehicle data systems. In particular, what is desired are vehicle data systems that can collect and analyze the actual historical transaction data to account for the complex and numerous variables (both inherent and exogenous) affecting the expected price of a vehicle and timely return accurate predictions of expected price variation through a user interface provided in real-time over an online distributed computer network. Furthermore, it may be desired that such data is analyzed and displayed in such a manner that sales forecasts are presented in a manner that allows users to easily ascertain where a vehicle's sales price on a given day falls within the cycle of expected price fluctuations.

To meet these needs, among others, attention is now directed to the aggregation, analysis, and display of accurate vehicle data in real-time over a network, including market trend data for both new and used vehicles. In particular, actual sales transaction data may be obtained from a variety of sources. This historical transaction data may be aggregated into data sets and the data sets processed to determine desired pricing data, where this determined pricing data may be associated with a particular configuration (e.g., make, model, power train, options, mileage, etc.) of a vehicle. An interface may be presented to a user where a user may provide relevant information such as attributes of a vehicle configuration, a geographic area, etc. The user can then be presented with a display pertinent to the provided information utilizing the aggregated data set or associated determined pricing data where the user can make a variety of determinations such as a trade-in price, a list price, an expected sale price or range of sale prices or an expected time to sale.

Specifically, in certain embodiments, a user can be presented with an interface including accurate market trends for a specified vehicle configuration over a computer based network in real time (e.g., through the use of a website). These marketing trends may include price ratio historical trend for a certain past time period (e.g., 30 days) and a prediction of price ratios for a certain future time period (e.g., the next 30 days). These historical trends may be segmented geographically (e.g., there may be a localized or national market price ratio historical trend for the past or future) or segmented by type of price (e.g., a sale price or an upfront price). In this manner, the user may make better pricing or purchasing decisions based on the presented market trend data. It will be apparent that such market trend data will be useful to both dealers and potential purchasers and thus may be usefully presented or utilized in conjunction with both consumer-facing or dealer-facing access points and interfaces.

In order to overcome the difficulties inherent in the determining and presenting such accurate market trend data in real-time over a network (e.g., through a website), embodiments of vehicle data systems as disclosed herein may employ certain architectural, data storage, or processing, systems and methods. For example, in certain embodiments, data may be collected and particular components of market trend data determined in a back-end process. The data or determined components may be stored and indexed to allow real-time lookup and access. A front-end online facing process may provide an interface where a user can provide relevant information such as attributes of a desired vehicle configuration, a geographic location, etc. The front-end process can then use the user specified vehicle configuration to access any needed components in real-time to generate and present an interface with the accurate market trend data desired by the user.

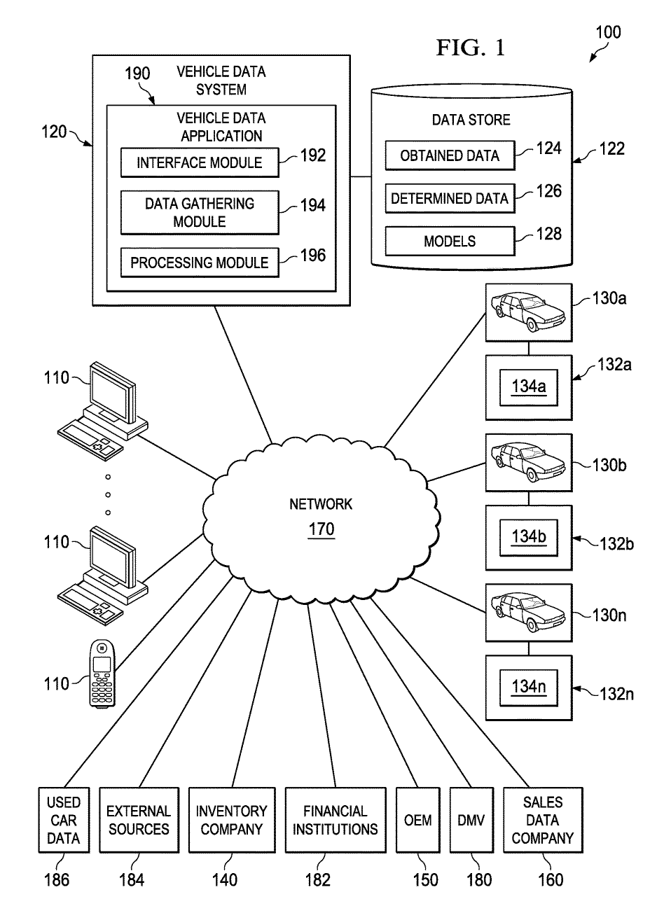

Embodiments of such vehicle data systems may be better explained with reference to FIG. 1, which depicts one embodiment of a topology that may be used to implement embodiments of the systems and methods disclosed herein. Topology 100 comprises a set of entities including vehicle data system 120 (also referred to herein as the TrueCar system) which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, aggregators of used car sales data (such as Edmunds, or NADA) 186, departments of motor vehicles (DMV) 180 and one or more associated point of sale locations, in this embodiment, car dealers 130. Network 170 may be for example, a wireless or wireline communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments of the present invention. These applications may include a vehicle data application 190 comprising one or more applications (instructions embodied on a computer readable media) configured to implement an interface module 192, data gathering module 194, and processing module 196 utilized by the vehicle data system 120. Furthermore, vehicle data system 120 may include data store 122 operable to store obtained data 124, data 126 determined during operation, models 128 which may comprise a predictive model 127 or a low volume model 129, or any other type of data associated with embodiments of or determined during the implementation of those embodiments.

Vehicle data system 120 may provide a wide degree of functionality including utilizing one or more interfaces 192 configured to, for example, receive and respond to queries from users at computing devices 110; interface with inventory companies 140, manufacturers 150, sales data companies 160, financial institutions 170, DMVs 180 or dealers 130 to obtain data; or provide data obtained, or determined, by vehicle data system 120 to any of inventory companies 140, manufacturers 150, sales data companies 160, financial institutions 182, DMVs 180, external data sources 184 or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, or almost any other type of interface which it is desired to utilize in a particular context.

In general, then, using these interfaces 192, vehicle data system 120 may obtain data from a variety of sources, including one or more of inventory companies 140, manufacturers 150, sales data companies 160, financial institutions 182, DMVs 180, external data sources 184 or dealers 130 and store such data in data store 122. This data may be then grouped, analyzed or otherwise processed by vehicle data system 120 to determine desired data 126 or models 128 which are also stored in data store 122. A user at computing device 110 may access the vehicle data system 120 through the provided interfaces 192 and specify certain parameters, such as a desired vehicle configuration or geographic data the user wishes to apply. The vehicle data system 120 can select a particular set of data in the data store 122 based on the user specified parameters, process the set of data using processing module 196 and models 128, generate interfaces using interface module 192 using the selected data set and data determined from the processing, and present these interfaces to the user at the user's computing device 110. More specifically, in one embodiment interfaces 192 may visually present the selected data set to the user in a highly intuitive and useful manner.

In particular, in one embodiment, a visual interface may present accurate market trends for a specified vehicle configuration. These marketing trends may include price ratio historical trends for a certain past time period (e.g., 30 days) and a prediction of price ratios for a certain future time period (e.g., the next 30 days). These historical trends may be segmented geographically (e.g., there may be a localized or national market price ratio historical trend for the past or future) or segmented by type of price (e.g., a sale price or an upfront price)

Turning to the various other entities in topology 100, dealer 130 may be a retail outlet for vehicles manufactured by one or more of OEMs 150. To track or otherwise manage sales, finance, parts, service, inventory and back office administration needs dealers 130 may employ a dealer management system (DMS) 132. Since many DMS 132 are Active Server Pages (ASP) based, transaction data 134 may be obtained directly from the DMS 132 with a “key” (for example, an ID and Password with set permissions within the DMS system 132) that enables data to be retrieved from the DMS system 132. Many dealers 130 may also have one or more web sites which may be accessed over network 170, where pricing data pertinent to the dealer 130 may be presented on those web sites, including any pre-determined, or upfront, pricing. This price is typically the “no haggle” (price with no negotiation) price and may be deemed a “fair” price by vehicle data system 120.

Inventory companies 140 may be one or more inventory polling companies, inventory management companies or listing aggregators which may obtain and store inventory data from one or more of dealers 130 (for example, obtaining such data from DMS 132). Inventory polling companies are typically commissioned by the dealer to pull data from a DMS 132 and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, Autotrader, FordVehicles.com, or the like).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from the DMS 132 systems of particular dealers 130. These companies may have formal agreements with dealers 130 that enable them to retrieve data from the dealer 130 in order to syndicate the collected data for the purposes of internal analysis or external purchase of the data by other data companies, dealers, and OEMs.

Manufacturers 150 are those entities which actually build the vehicles sold by dealers 130. In order to guide the pricing of their vehicles, the manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various sources, online or otherwise, which may provide other types of desired data, for example data regarding vehicles, pricing, weather, mileage, weather forecasts, recalls, publicity generating events, demographics, economic conditions, markets, locale(s), consumers, etc.

Used car data sources 186 include sources of data regarding used car sales, as well as sources of market making information for used car sales. Used car data sources 186 may include aggregators of used car sale data and used vehicle valuators such as Kelley, Edmunds and NADA. Used car data sources 186 may provide data regarding multiple price points that are of interest to participants in used car sales, including specifically list prices, sale prices, and trade-in prices.

It should be noted here that not all of the various entities depicted in topology 100 are necessary, or even desired, in embodiments of the present invention, and that certain aspects of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments of the present invention.

Before delving into the details of various embodiments of the present invention it may be helpful to give a general overview of an embodiment of the present invention with respect to the above described embodiment of a topology, again using the example commodity of vehicles. At certain intervals then, vehicle data system 120 may obtain by gathering (for example, using interface 192 to receive or request) data from one or more of inventory companies 140, manufacturers 150, sales data companies 160, financial institutions 182, DMVs 180, external data sources 184, used car data sources 186 or dealers 130. This data may include sales or other historical transaction data for a variety of vehicle configurations, inventory data, registration data, finance data, vehicle data, etc. (the various types of data obtained will be discussed in more detail later). It should be noted that differing types of data may be obtained at different time intervals, where the time interval utilized in any particular embodiment for a certain type of data may be based, at least in part, on how often that data is updated at the source, how often new data of that type is generated, an agreement between the source of the data and the providers of the vehicle data system 120 or a wide variety of other factors. Once such data is obtained and stored in data store 122, it may be analyzed and otherwise processed to yield data sets corresponding to particular vehicle configurations (which may include, for example, vehicle make, model, power train, options, etc.) and geographical areas (national, regional, local, city, state, zip code, county, designated market area (DMA), or any other desired geographical area). In some embodiments, it may be advantageous to collect data at night, after the close of dealers' business hours or other periods of low demand on vehicle data system 120 or other entities in topology 100.

At some point then, a user at a computing device may access vehicle data system 120 using one or more interfaces 192 such as a set of web pages provided by vehicle data system 120. Using interface 192, a user may specify a vehicle configuration by defining values for a certain set of vehicle attributes (make, model, trim, power train, options, etc.) or other relevant information, such as a geographical location. In the case of a used car, the user may also specify additional attributes, such as mileage or vehicle condition. Using interface 192, the user may also specify a purchase date, or window of purchase dates of interest. The user specified vehicle data may be used to locate one or more components previously determined and stored in a back-end process by the vehicle data system and associated with the specified vehicle configuration or geographic data provided by the user. These components may then be utilized to determine and present market trend data for the specified vehicle in real-time over the network 170 using a generated interface 192. This market trend data may include a historical trend of pricing for the specified vehicle or a forecast of the price of the specified vehicle relative to a reference price, such as MSRP, or in the case of a used vehicle, book price, on the specified date or date range. Both the back-end and the real-time processing of the data obtained or determined by the vehicle data system 120 will be discussed in more detail later in the disclosure.

In particular, market trend data associated with the specified vehicle configuration may be determined and presented to the user in a visual manner. Specifically, in one embodiment, a line graph or scatter plot visually presenting the fluctuation in the vehicle's price relative to the MSRP or other reference price over a time period (e.g., historical values or a future forecast) may be presented to the user via interface 192. The presented vehicle price may be, for example, a transaction price or an upfront price (a price guaranteed by dealers). Additionally, in some embodiments, the effect, or application of incentives or other price affecting milestones may be presented in conjunction with the display.

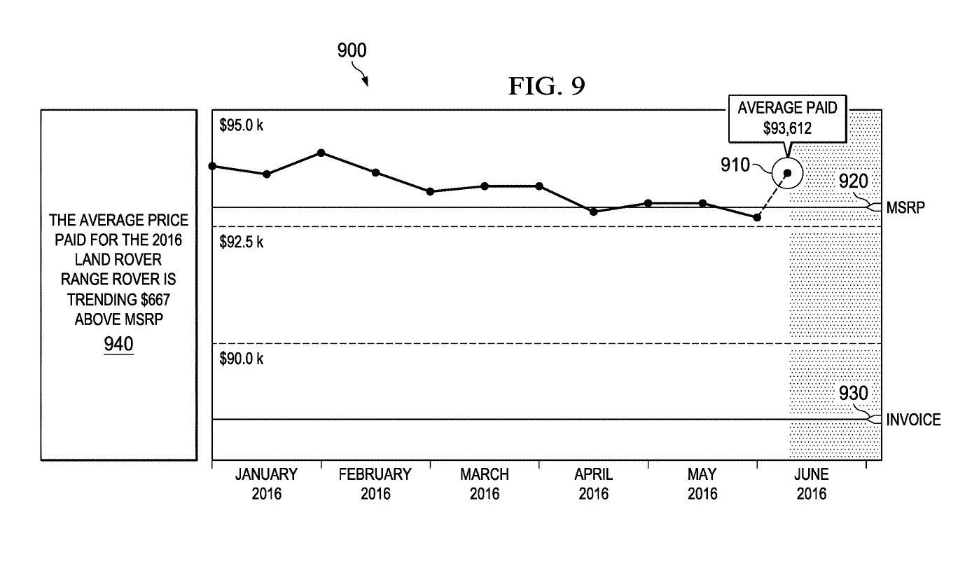

Briefly referring to FIG. 9, an example of an interface 900 for visually presenting predicted variations in the market price of a selected vehicle according to at least one embodiment of a vehicle data system is depicted. In this example, the price 910 is reported in units of currency over time as a line graph, and shown relative to both MSRP 920 and dealer invoice price 930. In this example, the market trend is characterized both visually and textually in sidebar 940.

As will be noted, the example of FIG. 9 is only one embodiment of how such market trend data may be presented. Generally, a visual interface may present at least a portion of the market trend data set as a price curve, bar chart, histogram, etc. that reflects quantifiable prices, price ratios or price ranges relative to reference pricing data points (e.g., invoice price, MSRP, dealer cost, market average, internet average, etc.). Using these types of visual presentations may enable a user to better understand vehicle price data related to a specific vehicle configuration. Additionally, by presenting data corresponding to different vehicle configurations in a substantially identical manner, a user can readily make comparisons between pricing data associated with different vehicle configurations. To further aid the understanding for a user of the presented data, the interface may also present data related to particular components which were utilized to determine the presented data or how such incentives were applied to determine presented data.

In one embodiment, the expected sale price, or sale prices within a range of expected sale prices may have a percentage certainty associated with them which reflect the probability of a specified used vehicle selling at that price. The list price and the expected sale price may be linked to a number of average days to sale such that the list price, expected sale price and average days to sale may be interdependent. The interface may offer a user the ability to adjust one or more pieces of this pricing data (e.g., the average number of days to sale) and thereby adjust the interface to present the pricing data calculated in response to this adjustment. Furthermore, such pricing data may be presented in conjunction with transaction data associated with the specified used vehicle. This transaction data may be presented as a distribution of the transaction data and include pricing data including price points such as market low sale price, market average sale price or market high sale price.

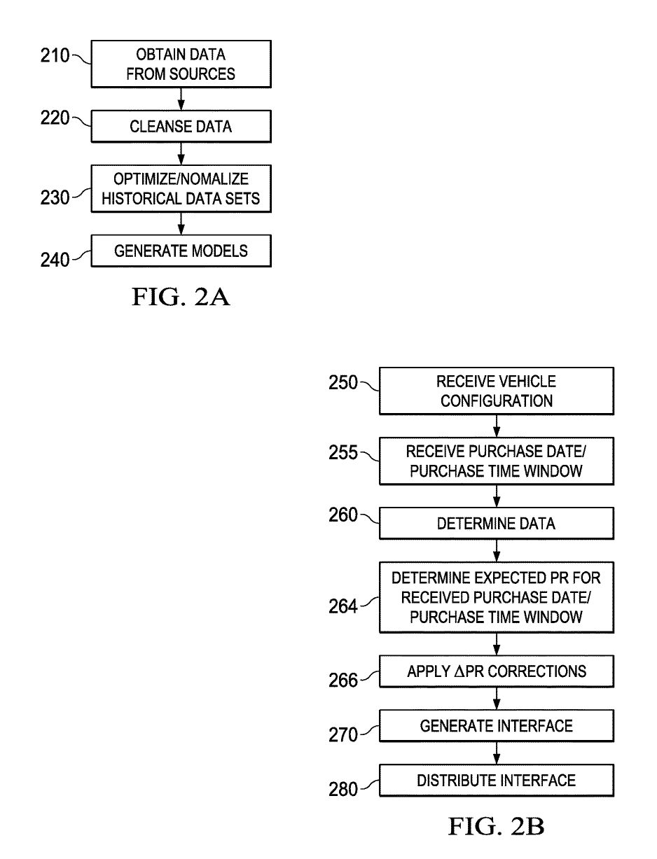

Turning now to FIGS. 2A and 2B, aspects of the operation of a vehicle data system are depicted. Referring first to the embodiment of FIG. 2A, at step 210 data can be obtained from one or more of the data sources (e.g., inventory companies 140, manufacturers 150, sales data companies 160, financial institutions 182, DMVs 180, external data sources 184, used car data sources 186, dealers 130, etc.) coupled to the vehicle data system 120 and the obtained data can be stored in the associated data store 122. In particular, obtaining data may comprise gathering the data by requesting or receiving the data from a data source. It will be noted with respect to obtaining data from data sources that different data may be obtained from different data sources at different intervals, and that previously obtained data may be archived before new data of the same type is obtained and stored in data store 122.

In certain cases, some of the operators of these data sources may not desire to provide certain types of data, especially when such data includes personal information or certain vehicle information (VIN numbers, license plate numbers, etc.). However, in order to correlate data corresponding to the same person, vehicle, etc. obtained from different data sources, it may be desirable to have such information. To address this problem, operators of these data sources may be provided a particular hashing algorithm and key by operators of vehicle data system 120 such that sensitive information in data provided to vehicle data system 120 may be submitted and stored in data store 122 as a hashed value. Because each of the data sources utilizes the same hashing algorithm to hash certain provided data, identical data values will have identical hash values, facilitating matching or correlation between data obtained from different (or the same) data source(s). Thus, the data source operators' concerns can be addressed while simultaneous avoiding adversely impacting the operation of vehicle data system 120.

Once data is obtained and stored in data store 122, the obtained data may be cleansed at step 220. The cleansing of this data may include evaluation of the data to determine if it conforms to known values, falls within certain ranges or is duplicative. When such data is found, it may be removed from the data store 122, the values which are incorrect or fall outside a threshold may be replaced with one or more values (which may be known specifically or be default values), or some other action entirely may be taken.

At step 230, the cleansed data may be optimized, and where appropriate, normalized and used to form sample sets of data. Normalization may include converting historical sales data which is expressed in dollars or other currencies into price ratios comprising the sale price divided by the MSRP, upfront price (UFP) or other reference value. In this way, historical sales data may be normalized. Normalization may also include performing adjustments (e.g., applying one or more adjustment factors) to account for inherent differences in how vehicle prices are reported. The application of such adjustment factors may prevent the differing (or changing) percentages of data coming from each source from impacting the accuracy of results.

Optimization may include grouping data into data sets according to geography (for example, national, regional, local, state, county, zip code, DMA, some other definition of a geographic area, such as within 500 miles of a location, etc.) and optimizing these geographic data sets for a particular vehicle configuration. In the case of used vehicles, the optimization may further comprise grouping data into sets according to mileage, condition or other parameters of particular interest to buyers and sellers of used vehicles. This optimization process may result in one or more data sets corresponding to a particular vehicle or group or type of vehicles, a set of attributes of a vehicle and an associated geography.

Using the data sets resulting from the optimization process, a set of models may be generated at step 240. These models may include a predictive model, which may determine a forecast of the expected market price (expressed in a currency or as a price ratio) of a given vehicle at a specified time. The predictive model may also provide a forecast of the vehicle's market price in a particular locality, or nationally. The models may also include a low volume model, to account for cases involving rare cars or other cases where the volume of data is insufficient to generate or obtain meaningful results by applying the predictive model. It will be noted that these models may be updated at certain intervals, where the interval at which each of the models (e.g., average price ratio model) is generated may, or may not, be related to the intervals at which data is obtained from the various data sources or the rate at which the other model(s) are generated.

Moving on to the portion of the embodiment depicted in FIG. 2B, at step 250 the vehicle data system 120 may receive a specific vehicle configuration through a provided interface 192. In one embodiment, for example, a user at a web page provided by vehicle data system 120 may select a particular vehicle configuration using one or more menus or may navigate through a set of web pages to provide the specific vehicle configuration. This specified vehicle configuration may comprise values for a set of attributes of a desired vehicle such as a make, model, trim level, one or more options, etc. The user may also specify a geographic locale where he is located or where he intends to purchase or sell a vehicle of the provided specification. At step 255, the user may also specify a purchase date or a range of purchase dates of interest.

Other information which a user may provide includes incentive data pertaining to the specified vehicle configuration. In one embodiment, when a user specifies a particular vehicle configuration, the vehicle data system 120 may present the user with a set of incentives associated with the specified vehicle configuration if any such incentives are available. The user may select zero or more of these incentives to apply.

Pricing data associated with the specified vehicle configuration may then be determined by the vehicle data system 120 at step 260. This data may include adjusted transaction prices, pricing data associated with the specified vehicle configuration within certain geographical areas (including, for example, the geographic locale specified). In one embodiment, the data may be selected using predetermined control logic to ensure a proper sample size. In some embodiments, the control logic may comprise a fallback binning logic, wherein the historical data may be grouped into a series of “bins” of historical sales data, and a data set is determined by choosing the bin of historical sales data for transactions most analogous (such as in terms of vehicle trim level, or proximity in time or location) to the parameters specified by the user at steps 250 and 255.

Using data from the selected bin of historical data, an expected, or baseline value of the price ratio (PR₀) for the selected vehicle on the specified purchase date or within a window of dates may be calculated at step 264, as will be discussed.

At step 266, using data from the selected bin of historical data, as well as data drawn from other sources shown in FIG. 1, corrections to PR₀ may be determined and applied to PR₀, to determine a market price forecast, as will be discussed.

An interface for presentation of the determined market trend data associated with the specified vehicle configuration may then be generated at step 270. These interfaces may comprise a visual presentation of such data using, for example, line charts, bar charts, histograms, Gaussian curves with indicators of certain price points, graphs with trend lines indicating historical trends or price forecasts, or any other desired format for the visual presentation of data. In particular, in one embodiment, the determined data may be fit and displayed as a line graph of price versus time associated with the specified vehicle configuration, along with visual indicators on, or under, the curve which indicate determined price points or ranges, such as one or more quantifiable prices or one or more reference price points (for example, invoice price, MSRP, dealer cost, market average, dealer cost, internet average, etc.). Thus, using such an interface, a user can easily assess the expected market or upfront price of a vehicle relative to their needs from the transaction. It should be noted here that though the interfaces elaborated on with respect to the presentation of data to a user in conjunction with certain embodiments are visual interfaces, other interfaces which employ audio, tactile, some combination thereof, or other methods entirely may be used in other embodiments to present such data.

The interfaces may be distributed through a variety of channels at step 280. The channels may comprise a consumer-facing network based application (for example, a set of web pages provided by vehicle data system 120 which a consumer may access over a network at a computing device such as a computer or mobile phone and which are tailored to the desires of, or use by, consumers); a dealer facing network based application (a set of web pages provided by the vehicle data system 120 which are tailored to the desires of, or use by, dealers); text or multimedia messaging services; widgets for use in web sites or in other application settings, such as mobile phone applications; voice applications accessible through a phone; or almost any other channel desired. It should be noted that the channels described here, and elsewhere, within this disclosure in conjunction with the distribution of data may also be used to receive data (for example, a user specified vehicle configuration or the like), and that the same or some combination of different channels may be used both to receive data and distribute data.

As may be apparent from a review of the above discussion, embodiments of vehicle data system 120 may entail a number of processes occurring substantially simultaneously or at different intervals and that many computing devices 110 may desire to access vehicle data system 120 at any given point. Accordingly, in some embodiments, vehicle data system 120 may be implemented utilizing an architecture or infrastructure that facilitates cost reduction, performance, fault tolerance, efficiency and scalability of the vehicle data system 120.

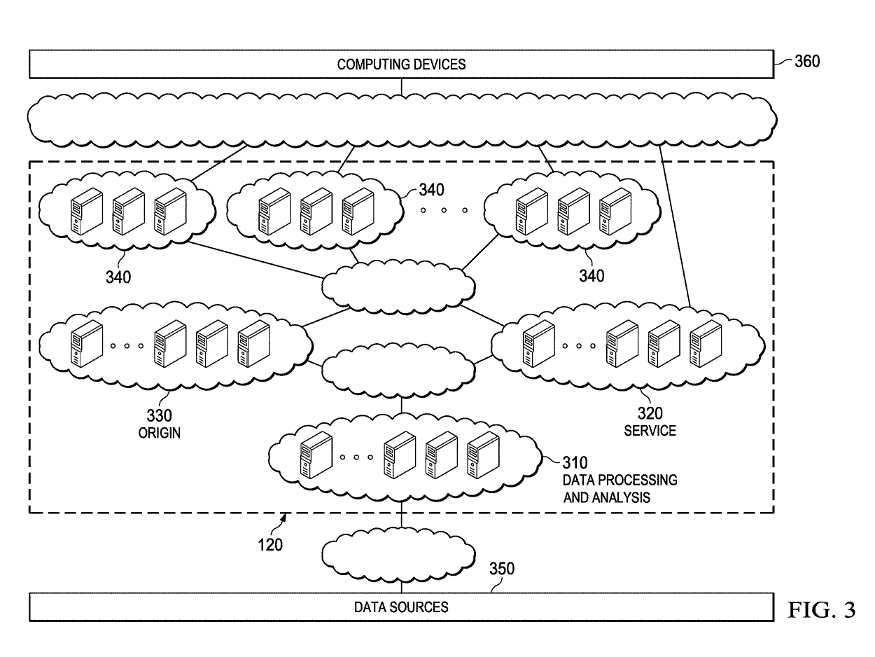

One embodiment of such an architecture is depicted in FIG. 3. Specifically, one embodiment of vehicle data system 120 may be operable to provide a network based interface including a set of web pages accessible over the network, including web pages where a user can specify a desired vehicle configuration and receive pricing data corresponding to the specified vehicle configuration. Such a vehicle data system 120 may be implemented utilizing a content delivery network (CDN) comprising data processing and analysis servers 310, services servers 320, origin servers 330 and server farms 340 distributed across one or more networks, where servers in each of data processing and analysis servers 310, services servers 320, origin servers 330 and server farms 340 may be deployed in multiple locations using multiple network backbones or networks where the servers may be load balanced.

The vehicle data system may include a back-end comprising data processing and analysis servers 320 which may interact with one or more data sources 350 (examples of which are discussed above) to obtain data from these data sources 350 at certain time intervals (for example, daily, weekly, hourly, at some ad-hoc variable interval, etc.) and process this obtained data as discussed both above in more detail later herein. This processing includes, for example, the cleansing of the obtained data, determining and optimizing sample sets, the generation of models, etc.

The back-end may also include origin servers 330 which may populate a web cache at each of server farms 340 with content for the provisioning of the web pages of the interface to users at computing devices 360 (examples of which are discussed above). Server farms 340 may provide the set of web pages to users at computing devices 110 using web caches at each server farm 340. More specifically, users at computing devices 360 connect over the network to a particular server farm 340 such that the user can interact with the web pages to submit and receive data through the provided web pages. In association with a user's use of these web pages, user requests for content may be algorithmically directed to a particular server farm 340. For example, when optimizing for performance locations for serving content to the user may be selected by choosing locations that are the fewest hops, the fewest number of network seconds away from the requesting client or the highest availability in terms of server performance (both current and historical), so as to optimize delivery across the network.

Certain of the web pages or other interfaces provided by vehicle data system 120 may allow a user to request services, interfaces or data which cannot be provided by server farms 340, such as requests for data which is not stored in the web cache of server farms 340 or analytics not implemented in server farms 340. User requests which cannot be serviced by server farm 340 may be routed to one of service servers 330. These requests may include requests for complex services which may be implemented by service servers 330, in some cases utilizing the data obtained or determined using data processing and analysis servers 310.

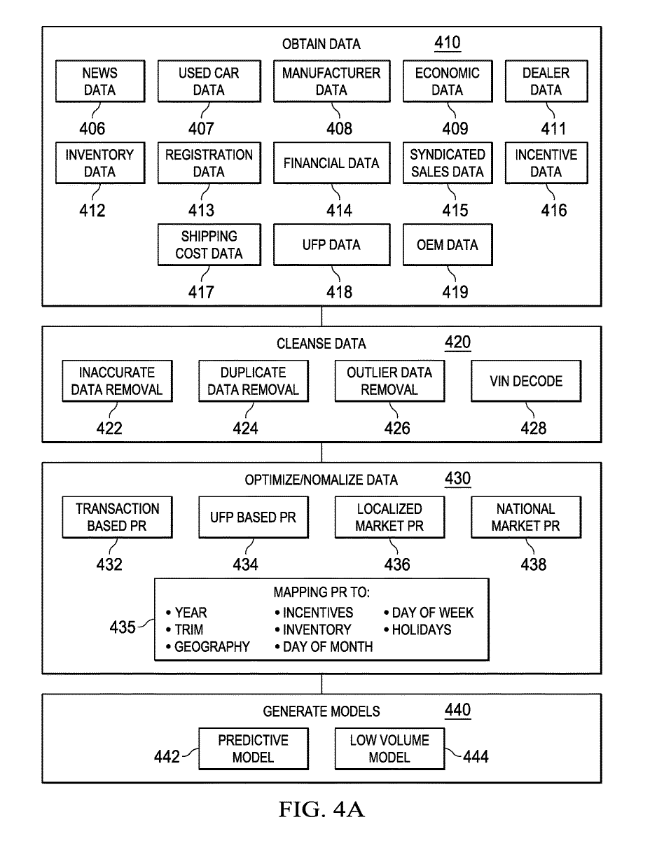

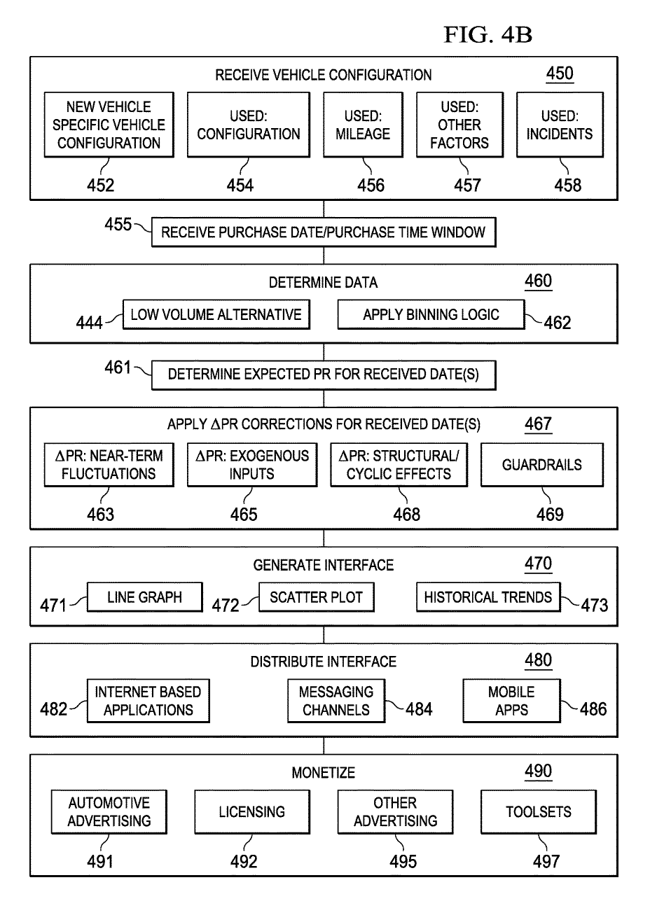

It may now be useful to go over in more detail, embodiments of methods for the operation of a vehicle data system which may be configured or operate according to embodiments of the above described architecture or another architecture altogether. FIGS. 4A and 4B depict one embodiment of how such a system may be configured to operate. Referring first to FIG. 4A, a diagram for an embodiment of a back-end process for obtaining and determining various data and models that may be utilized by a vehicle data system is depicted. Initially, at step 410 data can be obtained from one or more of the data sources coupled to the vehicle data system and the obtained data stored in a data store. The data obtained from these various data sources may be aggregated from the multiple sources and normalized. The various data sources and the respective data obtained from these data sources may include some combination of DMS data 411, inventory data 412, registration or other government (DMV, Sec. of State, etc.) data 413, finance data 414, syndicated sales data 415, incentive data 416, shipping cost data 417, upfront pricing data 418, OEM pricing data 419, manufacturer data 408, used car data 407, news/weather data 406 or economic data 409.

DMS data 411 may be obtained from a DMS at a dealer. The DMS is a system used by vehicle dealers to manage sales, finance, parts, service, inventory or back office administration needs. Thus, data which tracks all sales transactions for both new and used cars sold at retail or wholesale by the dealer may be stored in the DMS and obtained by the vehicle data system. In particular, this DMS data 411 may comprise data on sales transaction which have been completed by the dealer (referred to as historical sales transactions), including identification of a vehicle make, model, trim, etc. and an associated transaction price at which the vehicle was purchased by a consumer. In some cases, sales transaction data may also have a corresponding dealer cost for that vehicle. As most DMS are Active Server Pages (ASP) or Java Server Pages (JSP) based, in some embodiments the sales transaction or other DMS data 411 can be obtained directly from the DMS or DMS provider utilizing a “key” (for example, an ID and Password with set permissions) that enables the vehicle data system or DMS polling companies to retrieve the DMS data 411, which in one embodiment, may be obtained on a daily or weekly basis.

Inventory data 412 may be detailed data pertaining to vehicles currently within a dealer's inventory, or which will be in the dealer's inventory at some point in the future. Inventory data 412 can be obtained from a DMS, inventory polling companies, inventory management companies or listing aggregators. Inventory polling companies are typically commissioned by a dealer to pull data from the dealer's DMS and format the data for use on web sites and by other systems. Inventory management companies manually upload inventory information (for example, photos, descriptions, specifications, etc. pertaining to a dealer's inventory) to desired locations on behalf of the dealer. Listing aggregators may get data by “scraping” or “spidering” web sites that display a dealer's inventory (for example, photos, descriptions, specifications, etc. pertaining to a dealer's inventory) or receive direct feeds from listing websites (for example, FordVehicles.com).

Registration or other government data 413 may also be obtained at step 410. When a buyer purchases a vehicle it must be registered with the state (for example, DMV, Secretary of State, etc.) for tax, titling or inspection purposes. This registration data 413 may include vehicle description information (for example, model year, make, model, mileage, etc.) and a sales transaction price which may be used for tax purposes.

Finance and agreement data 414 may also be obtained. When a buyer purchases a vehicle using a loan or lease product from a financial institution, the loan or lease process usually requires two steps: applying for the loan or lease and contracting the loan or lease. These two steps utilize vehicle and consumer information in order for the financial institution to properly assess and understand the risk profile of the loan or lease. This finance application or agreement data 414 may also be obtained at step 410. In many cases, both the application and agreement include proposed and actual sales prices of the vehicle.

Embodiments of the vehicle data system may also be configured to obtain syndicated sales data 415 at step 410. Syndicated sales data companies aggregate new and used sales transaction data from the DMS of dealers with whom they are partners or have a contract. These syndicated sales data companies may have formal agreements with dealers that enable them to retrieve transaction data in order to syndicate the transaction data for the purposes of analysis or purchase by other data companies, dealers or OEMs.

Incentive data 416 can also be obtained by the vehicle data system. OEMs use manufacturer-to-dealer and manufacturer-to-consumer incentives or rebates in order to lower the transaction price of vehicles or allocate additional financial support to the dealer to help stimulate sales. As these rebates are often large (2%-20% of the vehicle price) they can have a dramatic effect on vehicle pricing. These incentives can be distributed to consumers or dealers on a national or regional basis. As incentives may be vehicle or region specific, their interaction with pricing can be complex and an important tool for understanding transaction pricing. This incentive data can be obtained from OEMs, dealers or another source altogether such that it can be used by the vehicle data system to determine accurate transaction, or other, prices for specific vehicles.

As dealers may have the opportunity to pre-determine pricing on their vehicles it may also be useful to configure the vehicle data system to obtain this upfront pricing data 418 at step 410. Companies like Zag.com Inc. enable dealers to input pre-determined, or upfront, pricing to consumers. This upfront price is typically the “no haggle” (price with no negotiation) price. Many dealers also present their upfront price on their websites and even build their entire business model around the notion of “no negotiation” pricing. These values may be used for a variety of reasons, including providing a check on the transaction prices associated with obtained historical transaction data.

Additionally, the vehicle data system may be configured to obtain OEM pricing data 419 at step 410. This OEM pricing data may provide important reference points for the transaction price relative to vehicle and dealer costs. OEMs usually set two important numbers in the context of vehicle sales, invoice price and MSRP (also referred to as sticker price) to be used as general guidelines for the dealer's cost and price. These are fixed prices set by the manufacturer and may vary slightly by geographic region. The invoice price is what the manufacturer charges the dealer for the vehicle. However, this invoice price does not include discounts, incentives, or holdbacks which usually make the dealer's actual cost lower than the invoice price. According to the American Automobile Association (AAA), the MSRP is, on average, a 13.5% difference from what the dealer actually paid for the vehicle. Therefore, the MSRP is almost always open for negotiation. An OEM may also define what is known as a dealer holdback, or just a holdback. Holdback is a payment from the manufacturer to the dealer to assist with the dealership's financing of the vehicle. Holdback is typically a percentage (2 to 3%) of the MSRP.

Although the MSRP may not equate to an actual transaction price, an invoice price can be used to determine an estimate of a dealer's actual cost as this dealer cost is contingent on the invoice. In some embodiments, this dealer cost can be defined as invoice price less any applicable manufacturer-to-dealer incentives or holdbacks. The vehicle data system may therefore utilize the invoice price of a vehicle associated with a historical transaction to determine an estimate of the dealer's actual cost which will enable it to determine “front-end” gross margins (which can be defined as the transaction price less dealer cost and may not include any margin obtained on the “back end” including financing, insurance, warranties, accessories and other ancillary products).

Data may also be obtained from a wide variety of other data sources, including economic data 409 related to the current, past or future state of almost any facet of the economy including gas prices, demographic data such as household income, markets, locale(s), consumers, or almost any other type of data desired. The economic data may be specific to, or associated with, a certain geographic area. Additionally, this economic data may comprise an internet index, which may be determined from the average price for a vehicle as reported by certain Internet research sites as the average price for a vehicle. Although these Internet research sites are typically consumer focused, they sell advertising and leads to the automotive dealerships; therefore their paying customers are dealerships and the prices on these sites tend to represent the higher end of the scale, favoring dealerships.

Other sources from which the vehicle data system may obtain data include manufacturer data 408, which may include manufacturers' suggested retail prices (MSRP), information about trim levels, color and VIN data which may be used as part of the data scrubbing process or elsewhere. The vehicle data system may also obtain geographic shipping cost data 417, to factor for shipping cost variations, such as to markets outside the continental United States, including Hawaii, Alaska or Guam. Other sources of data may include news/weather data 406, to provide notice of events that may bear on the volume or quality of purchase activity, such as heavy snowfalls. Other sources of data may also include used car data 407, which may include widely-consulted reference or “book” values of vehicles at various combinations of year, model, mileage, condition and trim, such as those provided by Kelley, Edmund's and NADA.

Once the desired data is obtained, the vehicle data system may be configured to cleanse the data at step 420. In particular, the data obtained may not be useful if it is inaccurate, duplicative or does not conform to certain parameters. Therefore, the vehicle data system may cleanse obtained data to maintain the overall quality and accuracy of the data presented to end users. This cleansing process may entail the removal or alteration of certain data based on almost any criteria desired, where these criteria may, in turn, depend on other obtained or determined data or the evaluation of the data to determine if it conforms with known values, falls within certain ranges or is duplicative. When such data is found it may be removed from the data store of the vehicle data system, the values which are incorrect or fall outside a threshold may be replaced with one or more values (which may be known specifically or be default values), or some other action entirely may be taken.

In one embodiment, during this cleansing process a VIN decode 428 may take place, where a VIN number associated with data (for example, a historical transaction) may be decoded. Specifically, every vehicle sold must carry a Vehicle Identification Number (VIN), or serial number, to distinguish itself from other vehicles. The VIN consists of 17 characters that contain codes for the manufacturer, year, vehicle attributes, plant, and a unique identity. Vehicle data system may use an external service to determine a vehicle's attributes (for example, make, model year, make, powertrain, trim, etc.) based on each vehicle's VIN and associate the determined vehicle information with the sales transaction from which the VIN was obtained. Note that in some cases, this data may be provided with historical transaction data and may not need to occur with respect to one or more of the historical transactions.

Additionally, inaccurate or incomplete data may be removed at a step 422. In one embodiment, the vehicle data system may remove any historical transaction data that does not include one or more key fields that may be utilized in the determination of one or more values associated with that transaction (for example, vehicle make, model, trim, etc.). Other high-level quality checks may be performed to remove inaccurate (including poor quality) historical transaction data. Specifically, in one embodiment, cost information (for example, dealer cost) associated with a historical transaction may be evaluated to determine if it is congruent with other known, or determined, cost values associated with the make, model or trim of the vehicle to which the historical transaction data pertains. If there is an inconsistency (for example, the cost information deviates from the known or determined values by a certain amount) the cost information may be replaced with a known or determined value or, alternatively, the historical transaction data pertaining to that transaction may be removed from the data store.

In one embodiment, for each historical transaction obtained the following actions may be performed: verifying that the transaction price falls within a certain range of an estimated vehicle MSRP corresponding to the historical transaction (e.g., 60% to 140% of MSRP of the base vehicle); verifying that the dealer cost for the transaction falls within a range of an estimated dealer cost (e.g., 70% to 130% of invoice−holdback of the base vehicle); verifying that a total gross (front end+back end gross) for the historical transaction is within an acceptable range (e.g., −20% to 50% of the vehicle base MSRP); verifying that the type of sale (new/used) aligns to the number of miles of the vehicle (for example, more than 500 miles, the vehicle should not be considered new).

Cleansing the data may also involve duplicate data removal 424. As there may be many sources for historical transaction data in many cases duplicative historical transaction data may be obtained. As such duplicative data can skew the results of the output of the vehicle data system, it may be desired to remove such duplicate data. In cases where uniquely identifiable attributes such as the VIN are available, this process is straightforward (for example, VINs associated with historical transactions may be matched to locate duplicates). In cases where the transaction data does not have a unique attribute (in other words, an attribute which could pertain to only one vehicle, such as a VIN, a combination of available attributes may be used to determine if a duplicate exists). For example, a combination of sales date, transaction type, transaction state, whether there was a trade-in on the transaction, the vehicle transaction price or the reported gross may all be used to identify duplicates. In either case, once a duplicate is identified, the transaction data comprising the most attributes source may be kept while the duplicates are discarded. Alternatively, data from the duplicate historical transactions may be combined in some manner into a single historical transaction.

Outlier data can also be removed 426. Outlier data is defined as data that does not appear to properly represent a likely transaction. In one embodiment, historical transaction data pertaining to transactions with a high negative margin (dealer loses too much money) or a high positive margin (dealers appears to earn too much money) may be removed. Removing outlier data may, in one embodiment, be accomplished by removing outlier data with respect to national, regional, local or other geographic groupings of the data, as removing outlier data at different geographic level may remove different sets of transaction data. In addition, relative or absolute trimming may be used such that a particular percentage of the transactions beyond a particular standard deviation may be removed off of the top and bottom of the historical transactions.

After step 420, cleansed data may be stored in a data store associated with the vehicle data system, where the cleansed data includes a set of historical transactions, each historical transaction associated with at least a set of vehicle attributes (for example, make, model, engine type, trim, etc.), a transaction price or front end gross, and the transaction date. Other data, such as geography, available incentives, inventory data, weather, or financial data associated with each transaction or transaction date may also be stored in the data store.

At step 430, then, the cleansed data may be normalized, for example by re-expressing historical price data as a price ratio (“PR”) of the sale price to one or more reference prices. The normalized historical price data may be expressed as a transaction based PR 432, an upfront price PR 434, a localized market PR 436 or a national market PR 438. The normalized data may then be mapped according to parameters 435, such as geography, time interval, available incentives, vehicle trim, whether a day is holiday, day of the month (“DoM”), day of the week (“DoW”), or inventory data. The mapped data may then be grouped into data sets using a binning process, and these data sets optimized for a particular vehicle configuration. This optimization process may result in one or more data sets corresponding to a specific vehicle or group or type of vehicles, a trim level or set of attributes of a vehicle, and an associated geography.

In order to make vehicle pricing data more accurate, it may be important to maintain timeliness or relevancy of the data presented or utilized. In one embodiment, then the total number of recent (within a desired time period) and relevant transactions may be optimized with respect to the cleansed data. Relevant data corresponding to a particular geographic region and a particular vehicle may be binned to optimize the quantity of data available for each vehicle within each geographic region. This quantity of data may be optimized to yield bins of historical transaction data corresponding to a trim level (a certain set of attributes corresponding to the vehicle) of a particular model car and an associated geography using geographic assignment of data and attribute categorization and mapping to trim.

During geographic assignment of data, data is labeled with one or more of: national (all data), regional, state, or DMA definition. Attribute categorization and trim mapping may also occur. Vehicle data can be sorted at the trim level (for example, using data regarding the vehicle obtained from a VIN decode or another source). This enables the accurate presentation of relevant pricing based on similar vehicles within a given time frame (e.g., optimizing recency). In some cases, a determination may be made that there is not a threshold quantity of data for a specific vehicle at a trim level to determine a statistically significant data corresponding to a time period.

In some embodiments, the vehicle data system may analyze vehicles at the model (e.g., Accord, Camry, F-150) level and run analytics at an attribute level (for example, drivetrain, powertrain, body type, cab type, bed length, etc.) to determine if there is a consistency (correlation between attributes and trims) at the attribute level. Since there are a greater number of transactions when binning at an attribute level, attribute level binning may be used instead of trim level binning in these situations, thereby yielding a larger number of historical transactions in a particular data set (relative to just trim level binning), but still relevant, data set to use for processing.

It will be noted with respect to these data sets that data within a particular data set may correspond to different makes, models, trim levels or attributes (e.g., geography) based upon a determined correlation between attributes. For example, a particular data set may have data corresponding to different makes or models if it is determined that there is a correlation between the two vehicles. Similarly, a particular data set may have data corresponding to different trims or having different attributes if a correlation exists between those different trim levels or attributes. This binning process is described in more detail at a later point herein.

Using the bins of historical transaction data then, a set of models may be generated at step 440 and stored in the data store of the vehicle data system. This model generation process may comprise generating a predictive model 442 for each of a set of bins of data of historical data. These predictive models may be later applied for market trend determinations for which there are bins of historical data that contain a statistically sufficient number data points to apply the market trend forecasting. The model generation process may also comprise generating a low volume data model 444, which may be used in cases where the historical transaction data may be too limited to determine or apply a predictive model 442.

In one embodiment, the basis for these models may be the price ratio (PR) of historical transactions for new vehicles, or inventory listings for used vehicles. In particular, in some embodiments the PR used in modeling may be the aggregated daily averages of the price ratio for all transactions in a bin (e.g., selected based on the fallback logic). For new cars, this price ratio may be defined as the transaction price divided by MSRP. For used cars, inventory data containing dealer listing prices are applied, along with transaction data for used vehicles. The original new-car MSRP for a used vehicle may still be used. However, because the price of a used vehicle can be significantly modified by mileage and vehicle condition, correction functions for these attributes may be applied in determining PR for used vehicles. These factors (C_cond and C_mileage) may be based on regression fits and predict percent change in PR for a vehicle relative to a bin center based on the deviation in condition and mileage from the bin center. The PR for an individual vehicle in historical data can be written as:

For New Vehicles:

PR=Transaction_Price/MSRP

For Used Vehicles:

PR=C_cond*C_mileage*Inventory_Price/MSRP

Inventory data prices (listing prices) may be used as the basis for used car pricing, however used transaction prices may be also applied as a cross check, allowing listing prices that are abnormally high or low to be removed from the fit. This allows used car prices to be verified across two different markets (inventory and transactions) before they enter any model. Used car pricing determination may be better understood with reference to U.S. patent application Ser. No. 14/145,252 filed Dec. 31, 2013, by Swinson et al., entitled “System and Method for Analysis and Presentation of Used Vehicle Pricing Data” and hereby incorporated herein by reference in its entirety.

In at least one embodiment, the system employs a predictive model that takes, into account, the aggregated daily averages of price ratios for all transactions in the bin chosen by the fallback logic, referred to herein as PR(t) or PR₀(t), and applies corrections to these values to account for modeled variations, such as near-term fluctuation, the effect of exogenous inputs, and/or structural features of the vehicle market.

The predictive models 442 may thus take the form:

PR(t)=PR₀(t)+Σⱼ₌₁^{N}^{ₐᵣ}αⱼ*ΔPR(t−j)+Σᵢβᵢ*xᵢ(t)+γ_{DoW}(t)+γ_{DoM}(t)+γ_{Holi}(t)

with

PR₀(t)=α₀+α₁t+α₂t²
calculated using a Nₕᵢₛₜ day training period.

These predictive models 442 may thus include a number of components that may be utilized to forecast a price ratio for a vehicle configuration for a number of days into the future (e.g., the next, or subsequent, 30 days). These components may include a first component, PR₀(t) pertaining to an estimate of the expected PR on a particular day using polynomial regression over historical values of PR for all transactions in the bin chosen by the fallback logic. The historical values of PR are determined over the period Nₕᵢₛₜ, which is the lookback period for training the polynomial fit component PR₀(t). It should be noted that other components of predictive models 442, such as the values of βᵢ and γ_{DoW}, may be trained over longer timescales. The geographical, structural, and temporal extents of these historical transactions will be based on binning or fallback logic as will be discussed.

The other components of the predictive model 442 may serve to predict the deviation from the expected value determined by the first component of the model. In one particular embodiment, the first component (e.g., the PR component) may be used to predict PR₀(t), using a polynomial fit to the PR of the transactions in the selected bin. This fit may be of degree 0, 1, or 2, and the choice of which to use may be based on training with available data. If the degree of the fit is 0, then PR₀(t) may be the average PR of the historical period. If it is one, then a “tilt” may be applied to PR₀, continuing linear trends that have been present over the historical period into the future time period (e.g., the next 30 days). A polynomial of 2 would normally be used for the largest bin (which may utilize a 180 day historical period) to allow additional flexibility in modeling long-term price trends.

A first adjustment component may be an autoregressive model, which predicts a variation (ΔPR) from the expected value on a particular day using the deviations of the past Nₐᵣ days as inputs. Nₐᵣ is decided by training on historical data over the temporal bin, and will normally be in the range 1<=Nₐᵣ<=10. The geographical and structural extent of these transactions will be at the same bin level selected in the first (PR) component. Nₐᵣ will be chosen based on training accomplished with historical data. The purpose of the piece is to account for short-term price fluctuations that are not captured by the other model components.

Another adjustment component may be an adjustment to PR predicted using available exogenous parameters to the model, including price incentives and dealer inventory age. This second adjustment component adjusts price in response to economic pressures that may influence a dealer. Specifically, in one embodiment this second adjustment component may be intended to adjust PR based on linear regression modeling of the effect on PR of exogenous inputs; namely variables external to historical PR that are related to economic or environmental conditions that can be expected to impact dealer pricing over a timescale (e.g., 1-30 days) and that can be forecasted with a reasonable degree of accuracy over this same time period. Customer and dealer incentives or dealer inventory age may be included to account for these key exogenous variables, as well as a transport adjustment for certain geographic locales (e.g., Alaska and Hawaii) to account for higher transportation costs.

Thus, in one embodiment, Δccash and Δdcash variables may be included. These variables use a combination of the incentives at time t and the average value in the historical bin.

$${ccash}_{t} = \frac{{customercash}_{t}}{msrp}$$

$${dcash}_{t} = \frac{{dealercash}_{t}}{msrp}$$

$$Δ {ccash}_{t} = {ccash}_{t} - {ccash}_{\{ binned avg \}}$$

$$Δ {dcash}_{t} = {dcash}_{t} - {dcash}_{\{ binned avg \}}$$

For example, it may be possible to determine or assume that the customer cash and dealer cash is at time t=0, and assume these incentives persist over the next 30 days.

To account for higher transportation costs in certain geographic locales (e.g., Alaska and Hawaii) dummy variables for these geographic regions may be included (e.g., if a geographical bin larger than a state is selected):

nonloc=1 if geographical level>State; else nonloc=0

AlaskaNonloc=isAlaska*nonloc

HawaiiNonloc=isHawaii*nonloc

The regression parameters for this component may be trained using an analysis of all historical data, which, as an example, can be 3 years. It will be noted with respect to this component that these examples of exogenous inputs for the model are provided by way of example only and that any number of alternative or additional exogenous inputs (including no exogenous inputs whatsoever) may be utilized in other embodiments. For example, other exogenous inputs that may be utilized include weather, or likelihood of inclement weather on a particular day, auto-industry or make level trends such as changes in global supply or model-year changeover, upcoming advertising campaigns or other publicity-generating events for a given make among others. Such exogenous inputs may be trained using historical data in the same way as the exogenous inputs described above entering the model as regression inputs with, for example, 3 years of history used as a training set.

A third adjustment component of the model may include an adjustment to PR based on the Day of Week (DoW), Day of Month (DoM), and Holiday (Holi) status of a target date. This adjustment component captures the large fluctuations in price that are known to occur on certain days of the week, at the end of the month, and on widely celebrated holidays. The magnitude of these corrections may be found using a stacking analysis of all historical data at a chosen bin geographical and structural level. The data utilized may be historical data from the past 3 years for the bin, but this time period may be greater or lesser as desired. A general formula for calculating this third adjustment component may be:

$$γ = ( \frac{1}{N} ) * \sum ( {PR}_{ave} - {PR}_{i} )$$

where PRᵢ are historical instances of the day in question, N is the number of such instances, and PRₐᵥₑ is the average PR for a period around PRᵢ. For DoW and DoM calculations, PRₐᵥₑ is taken to be the same week and same month as PRᵢ (weeks beginning on Monday and ending Sunday). For holiday corrections, PRₐᵥₑ can be the average PR for 6 months before to 6 months after the day in question.

In addition to the components described above, in certain embodiments predictive model 442 may have at least 2 additional configurable parameters: Nₐᵣ, which was discussed above and ΔPRₘₐₓ, a “guardrail” factor that is the maximum allowable value for |PR(t)−PR₀(t)|, the deviation predicted by the adjustment components described above. If predicted ΔPR for a given day falls outside this range, then these configurable parameters may reset ΔPR to the nearest allowed value (e.g., PR₀(t)±ΔPRₘₐₓ.) Generally, ΔPRₘₐₓ may be approximately equal to the largest deviation from PR₀ observed during the Nₕᵢₛₜ period. Nₐᵣ and ΔPRₘₐₓ may be set automatically at the make or segment level, on the basis of maximizing fit quality during data modeling. In certain embodiments, manual adjustments can be made by an administrator or provider of a vehicle data system if desired.

Referring now to low volume model 444, this model may be trained such that if there are not enough transactions in the highest level bin of data associated with a year, make, model or segment of a vehicle, this low volume model 444 may be utilized to forecast market trends for that vehicle. Such a low volume model 444 may determine binned averages at an even higher level, increasing that amount of pricing data available for training in cases with extraordinarily low sales volume. In particular, the low volume model 444 will be configured to calculate the binned averages at larger structural bins, such as year-make or make levels. In one embodiment, the actual algorithm applied for low volume model 444 will be the same as that for predictive model 442 with the only change being that the model parameters in the equation for predictive model 442 will be trained using such an expanded data set. For newly launched vehicles, low volume model 444 may also use data from the prior year's launch if available, as well as information about the magnitude of refresh, or if the model has been discontinued. A similar fallback scheme to that discussed above with respect to the predictive model 442 may also be used to generate exogenous inputs that are specific to a vehicle trim or model for low volume model 444. Low volumes may be better understood with reference to U.S. Pat. No. 8,612,314 entitled “System and Method for the Utilization of Pricing Models in the Aggregation, Analysis, Presentation and Monetization of Pricing Data for Vehicles and Other Commodities” by inventors Swinson et al, issued on Dec. 17, 2013 and hereby incorporated by reference in its entirety for all purposes.

It will be noted here, that the steps of FIG. 4A may be performed by a vehicle data system in a back-end process to obtain data from various data sources, bin this data at various levels and generate parameters for the components of predictive model 442 or low volume model 444 for these bins of vehicle data, among other tasks. As discussed these determinations may entail a huge (e.g., on the order of 10̂9 or greater) number of determinations or calculations and it may be prohibitive to accomplish such determinations in real-time. However, much of the data or models obtained or determined in this back-end process may be accessed in a real-time front end process. Accordingly, the obtained or determined data (e.g., the data bins) and the components of the predictive model 442 or low cost model 444 may be stored, sorted or indexed in the data store of the vehicle data system so as to allow real-time lookup, as well as rapid updates during model updates (which may occur daily). For example, in one embodiment, daily PRs for each bin may be indexed by a unique bin identifier (e.g., a string containing trim group, location, and model year), with the individual PRs stored in a dequeue (i.e., double ended queue) for efficient retrieval and update. Exogenous parameters and model parameters may be indexed in a similar way (e.g., a string containing model, dealer id, and date string, with one parameter per column). In this manner, the stored data and parameters may be accessed quickly, in real-time, using a vehicle configuration specified by a user in a front-end process.

With that in mind, FIG. 4B depicts one embodiment of a front-end process that may be performed by a vehicle data system utilizing the models or data determined in a back-end process. Initially, at step 450 the vehicle data system may receive a specific vehicle configuration 452 through a provided interface. In one embodiment, for example, a user at a web page provided by the vehicle data system may select a particular vehicle configuration using one or more menus or may navigate through a set of web pages to provide the specific vehicle configuration 452. The user may also specify a geographic locale where he is located or where he intends to purchase a vehicle of the provided specification, or may select one or more consumer incentives which the user may desire to utilize in conjunction with a potential purchase. The provided interface may also be used to obtain other data including incentive data pertaining to the specified vehicle configuration. In one embodiment, when a user specifies a particular vehicle configuration an interface having a set of incentives associated with the specified vehicle configuration may be presented to a user if any such incentives are available. The user may select zero or more of these incentives to apply.

At step 450, the vehicle data system may also receive further selections of specific interest to participants in the used vehicle market. For example, selections may include further configuration/modification data 454, mileage data 456, accident report data 458, and miscellaneous other data 457, such as the number of previous owners or whether the vehicle had been a fleet vehicle or used as a rent-a-car.

At step 455, the vehicle data system may receive selections as to one or more dates of interest and for which a market trend forecast for a selected vehicle is sought. In one embodiment, a user may select one or more dates on a pull-down calendar or slider presented on the provided interface. Alternatively, in other embodiments, the interface may also suggest or visually present predetermined or pre-calculated date ranges during which the fluctuation in market price is forecast to be favorable or unfavorable to a user. Such dates may be determined based on statistical information determined from the data set corresponding to the specified vehicle.

Data associated with the specified vehicle configuration which was provided by the user may then be determined by the vehicle data system at step 460. Specifically, in one embodiment, the vehicle data system may utilize a fallback binning logic 462 to select a data set that has a proper sampling size to provide, where possible, national, local, upfront price based or transaction based forecasts of the market trends for the vehicle having the trim, geography and other attributes specified via the user interface. In some embodiments, the selection of a fallback binning logic is based upon a categorization of the historical data into separate tranches, or bins, designed to capture sample sets of increasingly larger extents. These bins may have been predetermined and stored at the vehicle data system in a back-end process as discussed above.

Thus, in one embodiment, a set of bins may form a hierarchy from most specific to least specific, with each bin associated with a geography (e.g., DMA, state, region, national, etc.), a time (Nₕᵢₛₜ), or a structure (e.g., a vehicle definition defined by a trim level, a year, a make, a model or a vehicle segment). It is usually the case then, that data in a less specific bin will be a superset of data in a more specific bin. Fallback logic 462 may be configured to select the most specific of the set of bins that has a desired sample size of data. The order of the bins (e.g., the ordering from most specific to least specific) may be data-driven and selected to minimize trim group-volume weighted errors. Thus, fallback binning logic 462 will first test the sufficiency of the data (e.g., transactions) within the smallest or most specific bin. If the mean number of transactions per day Nₜᵣₐₙₛ(t) is insufficient, or too many days have Nₜᵣₐₙₛ below a critical value, then the next most specific bin may be evaluated to determine the sufficiency of data. As an example, a mean Nₜᵣₐₙₛ of 5 and no more than 5% of days in Nₕᵢₛₜ have 2 or fewer transactions may be a test for data sufficiency for a bin. If either of these conditions is violated, fallback logic 462 may retest data sufficiency at the next highest bin.

As an example, a first bin might contain all transactions involving the exact same trim group of the selected vehicle in the dealer market area (DMA) of the user's selection within the last sixty days. If this first bin contains an adequate sample size to implement a predictive model 442, then this data bin is used. If not, a more general bin, comprising, for example, all sales of vehicles having belonging to the same year, make and model as the selected vehicle, over a larger geographic region, such as an entire state, will be tested. If this second bin contains a sample size sufficient to implement a predictive model 442, the data in this bin is selected. If not, a determination is made as to whether the next most general data bin provides an adequate sample size. In the event that fallback binning logic 462 is unable to determine that the most broadly defined (e.g., least specific) data bin of the set of bins contains an adequate sample size, the vehicle data system determines a suitable data set using a low volume model 466. Embodiments of fallback binning logic 462 will be discussed in greater detail below.

In cases where the vehicle data system locates a data bin within a set of bins that comprises a data set providing a proper sampling size, at step 467 embodiments may be configured to determine an expected PR for the selected vehicle and date at step 461 based on the data in the bin and a stored predictive model 442. Alternatively, where the vehicle data system has not been able to find sufficient data in a set of bins using fallback binning logic, an expected price ratio may be determined based upon low volume model 444.

Having determined the expected PR for one or more points of time, embodiments of the vehicle data system may be configured to apply corrections to the expected price ratio determined at step 461 based on the modeled effects of various sources of fluctuation in PR. In some embodiments, the vehicle data system will apply a correction for near-term market fluctuations 463. Alternatively, a correction based on a modeling of the effects of exogenous inputs 465 may be applied. Again, these exogenous inputs or variables, which may be modeled and used to adjust a forecasted price ratio from the price ratio determined at step 461, may include dealer and customer cash incentives, dealer inventory age, transportation costs, weather, auto industry trends, or advertising campaigns or other publicity generating events for a given model. The vehicle data system may also be configured to provide a correction to PR based on structural/cyclical effects within the transaction data 468. Sources of structural/cyclical effects that can be modeled may include the day of the week, the day of the month, and holidays. Further, the vehicle data system may also be configured to implement one or more guardrails 469 on the corrections for modeled effects on expected price. In this way, if a calculated correction of PR exceeds a threshold value, also known as a guardrail, the correction will be limited to the guardrail value.

Based on the determined value of PR and application of corrections for modeled sources of fluctuation in PR, the market trend predictor may generate an interface for the presentation of a forecast of the market price of the selected vehicle at step 470. The interface generated may be determined in accordance with a user request received at the vehicle data system based on a user's interaction with other interfaces provided by the vehicle data system. In this manner, a user may “navigate” through the interfaces provided by the market trend predictor to obtain a market forecast and desired data about a specified vehicle configuration.

These interfaces may serve to communicate the market trend forecast and underlying data in a variety of visual formats, including streamlined normal distributions and pricing recommendations based on one or more data sets. In some embodiments, the forecasted fluctuation in the market price may be presented as a line graph 471, with time values on the x-axis, and the predicted fluctuations relative to a reference price (expressed either as PR or in currency) on the y-axis. In some further embodiments, the line graph may provide some indication as to the size of the deviation from the reference value to provide additional context as to advantageousness of a particular transaction date. Incentive data may also be displayed to the user.

In certain embodiments, the interface may provide a scatter plot of transaction data to the user to help visualize where the forecasted market price falls relative to historical price data 472. Interfaces for determined historic trends or forecasts 473 may also be generated. For example, a historical trend chart may be a line chart enabling a user to view how average transaction prices have changed over a given period of time. Other types of interfaces, such as bar charts illustrating specific price points (for example, average price paid, dealer cost, invoice, and sticker price) and ranges (for example, “good,” “great,” “overpriced,” etc.) in either a horizontal or vertical format, may also be utilized.

Using these types of visual interfaces may allow a user to intuitively understand a price forecast based on relevant information for their specific vehicle, which may, in turn, provide these users with strong factual data to understand the future pricing forecast relative to historical prices and therefore to negotiate, and understand when a good price (either for selling or buying) may be achieved and what such a price may be. Additionally, by displaying the data sets associated with different vehicles in substantially the same format, users may be able to easily compare pricing data related to multiple vehicles or vehicle configurations.

The generated interfaces can be distributed through a variety of channels at step 480. It will be apparent that in many cases the channel through which an interface is distributed may be the channel through which a user initially interacted with the vehicle data system (for example, the channel through which the interface which allowed the user to specify a vehicle was distributed). However, it may also be possible to distribute these interfaces through different data channels as well. Thus, interfaces which present data sets and the results of the processing of these data sets may be accessed or displayed using multiple interfaces and will be distributed through multiple channels, enabling users to access desired data in multiple formats through multiple channels utilizing multiple types of devices. These distribution methods may include but are not limited to: consumer and dealer facing Internet-based applications 482. For example, the user may be able access an address on the World Wide Web (for example, www.truecar.com) through a browser and enter specific vehicle and geographic information via its web tools. Data pertaining to the specific vehicle and geographic information may then be displayed to the user by presenting an interface at the user's browser. Data and online tools for the access or manipulation of such data may also be distributed to other automotive related websites and social networking tools throughout the web. These Internet-based applications may also include, for example, widgets which may be embedded in web sites provided by a third party to allow access to some, or all, of the functionality of the vehicle data system through the widget at the third party web site. Other Internet-based applications may include applications that are accessible through one or more social networking or media sites such as Facebook or Twitter, or that are accessible through one or more APIs or Web Services.

A user may also use messaging channels 484 to message a specific vehicle's VIN or time frame to the vehicle data system (for example, using a text, picture or voice message). The vehicle data system will respond with a message that includes a forecast of the market for the specific vehicle, as well the specific vehicle's pricing information (for example, a text, picture or voice message). Furthermore, in certain embodiments, the geographical locale used to determine the presented pricing information may be based on the area code of a number used by a user to submit a message or the location of a user's computing device. In certain cases, if no geographical locale can be determined, one may be asked for, or a forecast based on national historical sales data may be presented.

In one embodiment, a user may be able to use phone based applications 486 to call the vehicle data system and use voice commands to provide a specific vehicle configuration. Based on information given, the vehicle data system will be able to verbally present pricing data to the user. Geography may be based on the area code of the user. If an area code cannot be determined, a user may be asked to verify their location by dictating their zip code or other information. It will be noted that such phone based applications 486 may be automated in nature, or may involve a live operator communicating directly with a user, where the live operator may be utilizing interfaces provided by the vehicle data system.

As the vehicle data system may provide access to different types of vehicle data in multiple formats through multiple channels, a large number of opportunities to monetize the vehicle data system may be presented to the operators of such a system. Thus, the vehicle data system may be monetized by its operators at step 490. More specifically, as the aggregated data sets, the results or processing done on the data sets or other data or advantages offered by the vehicle data system may be valuable, the operators of the vehicle data system may monetize its data or advantages through the various access and distribution channels, including utilizing a provided web site, distributed widgets, data, the results of data analysis, etc. For example, monetization may be achieved using automotive (vehicle, finance, insurance, etc.) related advertising 491 where the operators of the vehicle data system may sell display ads, contextual links, sponsorships, etc. to automotive related advertisers, including OEMs, regional marketing groups, dealers, finance companies or insurance providers.

The operators of vehicle data system may also license 492 data, the results of data analysis, or certain applications to application providers or other websites. In particular, the operators of the vehicle data system may license its data or applications for use on or with certain dealer tools, including inventory management tools, DMS, dealer website marketing companies, etc. The operators of the vehicle data system may also license access to its data and use of it tools on consumer facing websites (for example, Yahoo! Autos or the like).

Monetization of the vehicle data system may also be accomplished by enabling OEMs to buy contextual ads 495 on certain applications such as distributed widgets or the like. Users may see such ads as “other vehicles to consider” on the interface. The operators may also develop and sell access to online tools 497 for OEMs, finance companies, leasing companies, dealer groups, and other logical end users. These tools 497 will enable customers to run customized analytic reports which may not be available on the consumer facing website, such as statistical analysis toolsets or the like.

As the improvements in vehicle data system functionality, expressed as the ability to simultaneously provide higher market trend forecast accuracy due to the ability to model for more factors than known systems and present market trend forecasts at the speeds desired by users of web-based systems, may be a significant advantage of the vehicle data system presented herein, it may now be useful to provide more details of the systems and methods utilized by embodiments of a vehicle data system to forecast market trends.

As an overview, embodiments of a vehicle data system construct a predictive forecast model or a low volume model based on a research data set. In certain embodiments, models may be constructed on one or more different levels, for example, a model may be built on a national level, a make level, a model level, a bin level, etc. Furthermore, there may be a set of models for each price which it is desired to determine. Thus, for example, there may be a set of models for list price, each model corresponding to a bin; a set of models for sale price, each model corresponding to a bin and a set of models for trade in price, each model corresponding to a bin.

In certain embodiments, the vehicle data system may be configured to implement an estimate of the expected PR on a particular day or range of days using polynomial regression over the aggregated daily averages of PR for all transactions in the bin chosen by the fallback logic. The data set of historical transactions used to perform this regression may be selected based on a combination of the transactions' geography (i.e., where the transaction took place), structural level of the transaction (for example, the make, trim level and year of the vehicle in the transaction), and the time of historical transactions.

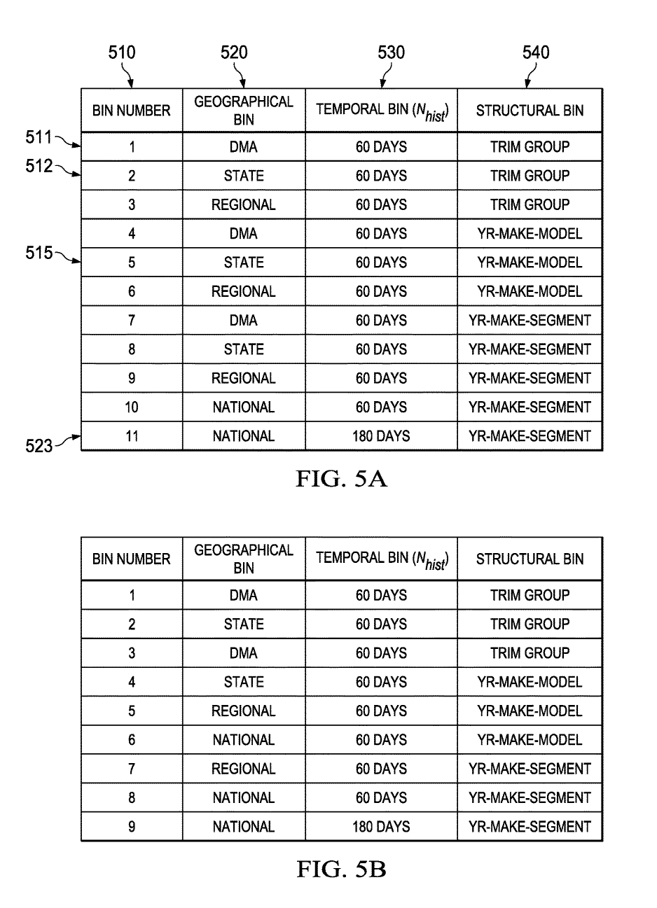

In some embodiments, the geographical, structural and temporal extents of the historical data set used to determine the expected PR will be determined using a fallback binning logic as discussed above. FIG. 5A provides an illustration of one example of a set of bins for use with fallback binning logic which may be used for determining a data set for forecasting trends in the market for a particular new vehicle according to one embodiment of the vehicle data system. Data associated with the various bins may be determined in a back-end process by a vehicle data system, and utilized in the back-end process (e.g., to determine or train a model or components thereof) or a front end process (e.g., to apply a model to determine market trend forecast for a bin). In particular, the data may be grouped as near as possible into the set of bins in the back-end process. The data can also be used to train models or components thereof associated with each bin if there is a threshold amount of data. Similarly, in the front-end process when the vehicle data system receives a specified vehicle configuration, geographic location or date it can determine the most specific bin of the set of bins that is both associated with the specified vehicle configuration or location and includes a threshold amount of data (e.g., number of transactions, or number of transactions within a time period). According to some embodiments, the selection of a bin and corresponding data set by the binning fallback logic may be accomplished using the bins shown in FIG. 5A ordered from most specific 511 to least specific 523.

In other words, when a specified vehicle configuration or geographic location is received the system may attempt to ascertain if there are a threshold number of transactions for the most specific bin associated with that specified vehicle configuration, if there are not a threshold number of transactions the binning fallback logic may evaluate (or “fallback” to) the next most specific bin. This evaluation may continue until a bin with a threshold number of transactions exists in a bin, or the least specific bin has been evaluated (e.g., at which point a low volume model may be utilized).

FIG. 5A presents a diagrammatic representation of one embodiment of a set of bins that may be used by fallback binning logic. Here, the cleansed and normalized historical transaction data in the data store of the vehicle data system may be categorized according to eleven “bins” 510 of progressively decreasing geographical, temporal and structural specificity. Geographical component or extent 520, is shown as having four tiers of geography, Dealer Market Area (“DMA”) (which is the smallest or most specific geography), state, regional and, most broadly, national tiers. In the embodiment of FIG. 5A, Temporal component or extent 530 is shown as having two tiers of temporal specificity, 60 days previous and 180 days previous to a certain date (e.g., before the end of the most recent day covered by the historical sales data in data store). In the embodiment of FIG. 5A, structural component or extent 540 has three tiers of “closeness” to a selected vehicle, at the most specific, a tier corresponding to sales of the same vehicle at the same trim group, then a tier for sales of the same make, model and year, and then a still broader tier for vehicles of the same year, make and vehicle segment (i.e., convertibles or S.U.V.'s). The definition and sequence of bins is data driven and, in this particular embodiment, chosen to minimize trim group-volume weighted errors. Skilled artisans will appreciate that other binning logic structures, involving different numbers of bins and differently selected bins are possible.

Thus, for example, all transactions in the historical data of the vehicle data system associated with transaction that occur within the same DMA, are associated with the same trim group and occurred within the past 60 days may be associated with one another and bin 1 (511). For example, all transactions occurring within the “Austin” DMA that occurred within the past 60 days associated with the Ford Focus RS may be associated with one another and bin 1 (511). Similarly, all transactions occurring within the “Houston” DMA that occurred within the past 60 days associated with the Volkswagen Golf R may be associated with one another and bin 1 (511). Notice as well that historical transaction data may be associated with all bins to which it belongs. To continue with the above examples, all transactions occurring within Texas that occurred within the past 60 days associated with the 2016 Ford Focus may be associated with one another and bin 5 (515). Thus the transactions occurring within the “Austin” DMA that occurred within the past 60 days associated with a 2016 Ford Focus RS that are associated with bin 1 (511) may also be associated with the transactions for 2016 Ford Focus occurring within Texas and bin 5 (515). Moreover, all transactions occurring within Texas that occurred within the past 60 days associated with the 2016 Volkswagen Golf may be associated with one another and bin 5 (515). Accordingly, the transactions occurring within the “Houston” DMA that occurred within the past 60 days associated with a 2016 Volkswagen Golf R that are associated with bin 1 (511) may also be associated with the transactions for 2016 Volkswagen Golf occurring within Texas and bin 5 (515).

Accordingly, in one embodiment, when a vehicle data system receives a specified vehicle configuration or attempts to create or train a model for a bin, the vehicle data system may obtain the narrowest bin, bin 1 (511) of data associated with the specified vehicle and location (e.g., all historical transactions for vehicles of the same trim level occurring in the same DMA as the location in the past 60 days) and determine whether the mean number of transactions per day in the bin meets a threshold or whether too many days in the bin have a number of transactions below a threshold. If either of either of these conditions are violated, then, according to the fallback binning logic, the next bin (e.g., bin 2 (512) comprising all historical transactions for vehicles of the same trim level occurring in the state of the location in the past 60 days) is tested for data sufficiency. In some embodiments, the conditions for data sufficiency may require a mean number of transactions of at least 5 transactions a day and no more than 5% of the days have fewer than 2 transactions per day. In certain embodiments, a temporal bin 530 of 60 days is typical, but may be increased to as high as 180 days (or more) in the case of noisy or insufficient data. Applying the fallback binning logic, the first bin of data to satisfy the data sufficiency conditions may be used. In particular, the data of the bin may be loaded into a cache at the vehicle data system so that such data may be more quickly accessed during such processing to increase the speed of processing and response. In the event that the fallback binning logic fails to locate a bin satisfying the data sufficiency conditions, then the vehicle data system may apply a low volume model.

Turning now to FIG. 5B, which provides an illustration of fallback binning logic which may be used for determining a data set for forecasting trends in the market for a particular used vehicle according to certain embodiments of a vehicle data system. In this example, optimizing the fallback structure for used cars may result in a binning structure in which fewer bins are used than in the example of FIG. 5A, and the sequencing of the geographical bins may be different than in FIG. 5A.

As has been explained, when training a model or evaluating a specified vehicle configuration and location provided by a user, historical transaction data associated with a particular bin may be utilized. Specifically, in one embodiment, as described above, a baseline estimated price ratio PR₀(t) for the selected date or range of dates may be determined by performing a polynomial fit of the historical data across the full time period of the determined data set. The fit may be of any degree, including 0, 1, or 2, and the choice of which degree to use may be based on training the vehicle data system with available data. If the degree of the fit is 0, then PR₀(t) is the average PR of the historical period. If it is one, then the vehicle data system may apply a “tilt” to PR₀, continuing linear trends that were present in the historical period into the future. A polynomial fit of 2 may be used, for example, for larger bins, to enable greater flexibility in modeling long-term price trends.

Skilled artisans appreciate that such a price ratio prediction \hat{Ψ}ₜ for a given time t (e.g., a particular day) may be determined using a regression of the general form:

$${\hat{Φ}}_{t} = {\overline{Φ}}_{j , k} = \frac{1}{\vert k - j \vert + 1} {\sum }_{i = j}^{k} {φ}_{i}$$

. . . where Ψ̅_{j,k} represents an average price ratio obtained as an ordinary average of, e.g., daily price ratios φᵢ spanning days j to k.

In embodiments in which the fallback binning logic is unable to determine PR₀(t) as described in the embodiment above, embodiments of a low volume model may be implemented to determine PR₀(t). According to such embodiments, the vehicle data system may be configured to handle the two principal situations: (1) the release of a new model year; and (2) a scarcity of transactions, in which there is not sufficient historical sales data to identify a set of data using fallback binning logic.

In cases in which a new model year is released, the low volume model may comprise blending the trim group PR data to include PR data from the previous year's version of the same trim group. In such embodiments, the relative sizes of the previous year's data may be weighted as a fraction of the total data, to avoid simply averaging the data. Thus, in cases where a 60 day historical interval is used to determine PR₀(t), of which data for the new year's vehicle exists for 45 days, and an additional 15 days of previous data from the previous model year is required to form a sufficient data set, a 3:1 weighting of the current data to the old data may be used in determining PR₀(t).

In other cases, where there is an overall scarcity of historical transaction data, PR₀(t) may be determined by generating a historical average of PR for the vehicle in question at larger structural bins, such as year-make or make, to which the corrections discussed elsewhere in this specification may be applied. In certain embodiments, the performance of a vehicle data system may be further improved by correcting PR₀(t) to account for near-term fluctuations in transaction price not captured by other model components.

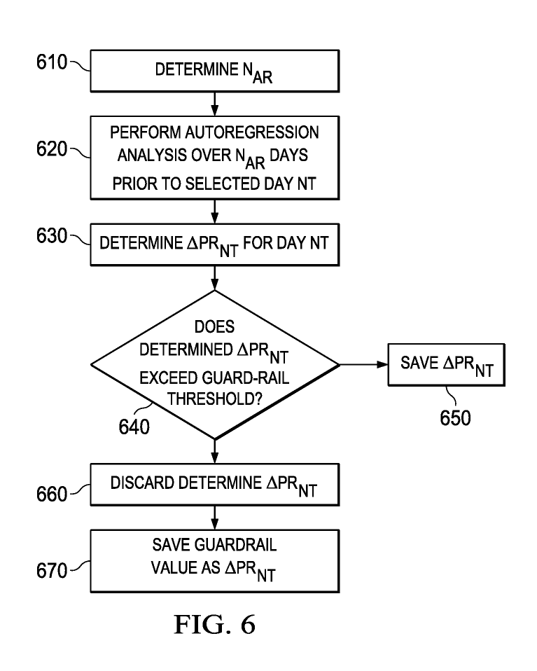

An example of determining the correction for near-term fluctuations according to certain embodiments may be described with reference to FIG. 6. In this example, the deviation from PR₀(t) may be determined by applying an autoregressive model, using the deviations of the past Nₐᵣ days as inputs, where Nₐᵣ is a recent subset of the temporal bin of the determined data set (e.g., bin). The geographical and structural components of these transactions utilized will be the same as the geographical and structural components of the selected data. According to some embodiments, Nₐᵣ will be chosen at step 610 based on training on historical data, with Nₐᵣ typically being in the range of 1 to 10 days.

At step 620, the vehicle data system may perform an autoregression analysis on the historical data set over the past Nₐᵣ days. According to certain embodiments, processing module may apply an autoregressive analysis for a given time t (e.g., a particular day) of the general form:

$$\{ \frac{1}{n} {\sum }_{i = 1}^{n} {α}_{i} * ( {φ}_{t - i} - \overline{Φ} ) + {ɛ}_{t} \}$$

wherein the autoregression is performed across the previous n days behind the current time index t; where αᵢ represent the regression parameters that are numerically optimized to fit the autoregression function to historical price ratio data, (φₜ₋ᵢ−Ψ̅) represents the time-perturbed deviations of historical price ratios φₜ₋ᵢ from the average price ratio Ψ̅, and εₜ represents the error associated with autoregressive modeling.

At step 630, the results of the autoregression analysis performed at step 620 are expressed as one or more values for ΔPR_{NT}(t), where ΔPR_{NT}(t) represents the modeled deviation in PR at one or more selected dates.

At step 640, the vehicle data system may compare the determined value of ΔPR_{NT}(t) against a maximum allowable value, or “guardrail.” The guardrail can serve as a check on corrections for near term fluctuations by ensuring that the magnitude of the near-term correction applied does not exceed the fluctuations of observed near term fluctuations. According to some embodiments, the value of the guardrail for near-term fluctuations will be determined by training the vehicle data system on historical data to identify the point at which a determined value of ΔPR_{NT}(t) is of a scale that is statistically improbable.

If the determined value of ΔPR_{NT}(t) does not exceed the guardrail value, embodiments of a vehicle data system may proceed to step 650, at which the determined value of ΔPR_{NT}(t) is saved. If the determined value of ΔPR_{NT}(t) is found to exceed the guardrail value, the system may discard the determined value of ΔPR_{NT}(t) at step 660, and instead save the guardrail value as ΔPR_{NT}(t) at step 670.

In certain embodiments, performance of the vehicle data system may be further enhanced by configuring the system to model and apply corrections to PR₀(t) to account for the effect of exogenous inputs or variables external to historical PR that are related to economic or environmental conditions that can be expected to impact transaction prices over near- to medium-term time scales (typically, between 1-30 days), and that can be forecast with a reasonable degree of accuracy over this same time period.

Examples of exogenous variables whose effect can be modeled have been discussed and may include, for example, dealer and customer cash incentives, dealer inventory age, transportation costs, weather, or the likelihood of inclement weather on a particular day, auto-industry or make level trends such as changes in global supply or model-year changeover and upcoming advertising campaigns or other publicity-generating events (for example, product recalls) of a given make. Skilled artisans will appreciate that the foregoing is not an exhaustive list of the exogenous variables which may induce variation in the market price for vehicles and for which vehicle data systems may be configured to account for.

In an illustrative example, vehicle data system may apply corrections to PR₀(t) to account for fluctuations in PR from the following inputs: customer cash incentives (for example, manufacturer-to-customer cash back type incentives), dealer cash incentives (for example, manufacturer-to-deal cash back type incentives, or manufacturer holdbacks), dealer inventory age, and transportation or freight fees.

The effect of customer cash incentives may be determined by first determining ccashₜ, a normalized expression of the size of the customer cash incentive(s). Ccashₜ may be expressed as:

$${ccash}_{t} = \frac{{customercash}_{t}}{msrp}$$

where customercashₜ is the dollar value of the customer cash incentive as a function of time. In the absence of further data as to the future value of customercashₜ, it can be assumed, without undue error to the market forecast, that the incentive will persist over the next 30 days.

Ccashₜ may then be compared against the average value of customercash/msrp for all of the binned transactions in determined data to determineΔccashₜ, where Δccashₜ is the variable to be applied to the modeled correction for customer cash incentives, as shown below:

Δccashₜ=ccashₜ−ccash_{{binned avg}}

A linear regression over a longer period of historical data, such as, for example, three years, may be performed to determine a linear correction of the general form:

$$\{ {β}_{0} + {\sum }_{i = 1}^{n} {β}_{i} {X}_{i , t} \}$$

Where β₀ represents the intercept (i.e., the value of the criterion when the predictor is equal to zero) of the linear regression analysis for exogenous variables i₁ through iₙ, and βᵢ is the linear regression parameter for each exogenous variable, which are optimized to fit the linear regression function to historical price ratio data.

In this example, n=4, as four exogenous variables are being accounted for by the linear correction shown above. The effect of dealer cash incentives is determined similarly to that of customer cash incentives, by first normalizing the dealer cash data as dcashₜ, shown below:

$${dcash}_{t} = \frac{{dealercash}_{t}}{msrp}$$

The difference between dcashₜ and the mean dcash values in the binned historical transaction data of the determined data is determined to get Δdcashₜ, shown below:

Δdcashₜ=dcashₜ−dcash_{{binned avg}}

According to some embodiments, a linear regression analysis across a relatively large swathe of historical transaction data may be performed to determine the effect of the variable Δdcashₜ on PR.

Skilled artisans will appreciate that a similar linear regression may be applied to determine a linear expression of the effect of, for example, dealer inventory age and derive the corresponding β value and contribution to δ₀ for inventory age.

To account for cases in which the geographical component of determined data includes states having inherently different vehicle transportation or freight costs, such as Alaska or Hawaii, a dummy variable attached to transactions in the historical data set which occurred in such states may be used. Logic for implementing an exemplary geographical dummy variable, nonloc is shown below:

nonloc=1 if geographical level>State; else nonloc=0

AlaskaNonloc=isAlaska*nonloc

HawaiiNonloc=isHawaii*nonloc

Using geographical dummy variable nonloc, a linear regression across the historical data set may be conducted to compensate for the effects of shipping or freight costs on PR₀(t).

In some embodiments, the market price predictor system may be configured such that a maximum value or “guardrail” for corrections based on exogenous variables may be implemented. For example, in the example above, where the value of the correction for exogenous variables 1 through n {β₀+Σᵢ₌₁ⁿβᵢX_{i,t}} exceeds this maximum value, the correction applied to PR₀(t) for exogenous variables will be the guardrail value, rather than the determined value of β₀+Σᵢ₌₁ⁿβᵢX_{i,t}.

In accordance with some embodiments, the vehicle data system may be configured to provide corrections to PR₀(t) to account for what may be termed cyclical or structural effects in the vehicle market. Skilled artisans will appreciate that the vehicle market has its own rhythms, with some days (such as certain holidays and weekends) consistently being associated with greater transactional volume, and certain periods of the week or month being associated with greater customer demand or greater pressure on dealers to sell cars.

To still further improve performance, embodiments of the vehicle data system may be configured to apply a further correction to PR₀(t) to account for the effects of the aforementioned structural features of the market. In one such illustrative embodiment, corrections for the structural effects of the day of the week, days remaining in the month and holidays may be applied. Skilled artisans will appreciate that, in the context of the vehicle market, “holidays” may include both calendar holidays and days consistently associated with heightened market activity, such as “Black Friday.”

In an illustrative embodiment, three fixed corrections are applied to PR₀(t) to account for the day of the week, days remaining in the month, and whether the selected purchase date(s) include a holiday. The magnitude of these corrections is found using a stacking analysis of all of the historical data belonging to the same geographical and structural bin as the determined data. According to one embodiment, the analysis shown below is performed on geographically and structurally analogous historic data to determine values γᵢ₋ₙ for each of the n structural factors, where γ is an offset to PR₀(t) applied when the day in question matches a particular value for a day of the month, day of the week, or holiday.

$$γ = ( \frac{1}{N} ) * \sum ( {PR}_{ave} - {PR}_{i} )$$

Where PRᵢ are individual historical instances of the day in question, N is the number of such instances within the historical data set, PRₐᵥₑ is the average PR for a period around PRᵢ. Depending on the frequency of the day in question, the period over which PRₐᵥₑ is determined may be lengthened or shortened as appropriate. For example, for a day of the week correction, the period over which PRₐᵥₑ is determined must be six days or less, to avoid conflating the day of interest with the baseline. However, for holidays and less frequently occurring days, PRₐᵥₑ may be determined over a longer temporal window. For example, according to some embodiments, when calculating γ for holidays, PRₐᵥₑ may be the average PR for six months before to six months after the day in question. In some cases, the value for day of the month, day of the week or holiday may be expressed using a dummy variable. For example, γₕₒₗᵢ may be a step function having only two values for holiday=0 (day is not a holiday) and holiday=1 (day is a holiday).

As with the corrections to market price due to near-term fluctuations and exogenous variables, a vehicle data system may be configured to implement a “guardrail” or maximum value limit for the total offsets due to structural/cyclical factors. In such cases, the correction applied to PR₀(t) for structural values is the value of the guardrail, rather than the sum of the applicable offsets.

Having determined corrections for near-term fluctuations, exogenous variables and structural/cyclical effects in the vehicle market, one embodiment of the vehicle data system determines a corrected forecasted value of the price ratio for a selected vehicle at one or more times (t) as the sum of PR₀(t) and each of the modeled corrections. According to some embodiments the determination of the forecast may be expressed formally as shown again here:

PR(t)=PR₀(t)+Σⱼ₌₁^{N}^{ₐᵣ}αⱼ*ΔPR(t−j)+Σₜβᵢ*xᵢ(t)+γ_{DoW}(t)+γ_{DoM}(t)+γ_{Holi}(t)

where Σⱼ₌₁^{N}^{ₐᵣ}αⱼ*ΔPR(t−j) constitutes the correction for near-term fluctuations determined by autoregressive analysis of the subset of determined data for the period from the most recent entry in determined data going back Nₐᵣ number of days.

Σᵢβᵢ*xᵢ(t) represents the total correction for each of the exogenous variables. Where γ_{DoW}(t)+γ_{DoM}(t)+γ_{Holi}(t) represent offsets for selected structural/cyclical effects—in this case, the day of the week, the days remaining in the month and whether a day is a holiday.

As discussed elsewhere, embodiments of the vehicle data system may afford improvements in performance beyond those possible with prior art systems (performance expressed in terms of the ability to input and model very large amounts of data from numerous sources and, at the same time, provide users with market trend forecasts at the speeds expected by modern computer users (e.g., in real-time)).

In some embodiments, to increase the efficiency of the process and to timely provide market trend predictions which tailor the results to the individual user's unique specifications, it may be desirable for vehicle data systems to employ an architecture built around a back-end process that creates or “pre-computes” certain data or components that may be utilized in a real-time front-end process that provides market trend forecasts to users of the vehicle data system. As used herein, “back-end” refers both to system or modules functioning in a manner other than in response to a specific user request received through the front-end, or which may be done at a point prior to receiving a user request for data on a specific vehicle (including results not calculated in immediate response to a user request, or which may be calculated at any point prior to receiving a particular user requests). By contrast, “front end” refers to the portions of the system and associated modules or processes performed in response to receiving a user input (e.g., through an interface), such as a request for a market trend prediction on a specific vehicle.

The following is a description of the computational load demanded by one embodiment of a vehicle data system configured to provide determinations of PR(t) based on historical transaction data. In this embodiment, input parameters used by the vehicle data system may be precomputed. Here, daily price ratios for the vast majority of new cars available in the United States may be calculated at the trim group level, with about 2000-3000 different vehicles and trim levels for each model year. In this embodiment, such daily price ratios would be computed for the last 30 years. In this embodiment, price ratios are also aggregated geographically at the DMA, state, region and national levels, resulting in approximately 267 location bins to consider. Further, modeling the used car market requires independently tracking 25 model years. With a 60 day lookback in the last fallback bin, this exemplary embodiment computes approximately 10̂9 daily PR averages.

In this embodiment, daily records for PRs and exogenous variables for a longer period of approximately three years, are used to train the vehicle data system to determine and apply corrections for exogenous variables and structural/cyclical effects in the vehicle market.

Once the data inputs (for example, PR values, average PR values, Δccashₜ) are determined, regressions to calculate the fit parameters (e.g., αᵢ, βᵢ, γ_{DoM}, etc.) are calculated across all bins and stored in a database for access at speeds customary for websites providing interfaces to market information systems. The table below provides the estimated sizes for the data products used in this implementation of the vehicle data system.

| | | Rows × | Daily |
|---|---|---|---|
| Item | Description | Columns | Modifications |
| daily PR (from | PR averages for past 60 days, | ~2 * | ~2 * 10\hat{ }7 |
| 60 days ago to | aggregated to trim group level, at | 10\hat{ }7 × | |
| one day ago) | DMA, region, and state levels, for | 60 | |
| | past ~25 model years | | |
| daily PR (from | PR averages for 180 days ago to 60 | ~10\hat{ }4 × | 10\hat{ }4 |
| 61 days ago to | days ago, at yr-make-segment level, | 120 | |
| 180 days ago) | national only, for past 25 model | | |
| | years | | |
| daily PR (from | PR averages at yr-make-model | 10\hat{ }4 × | 10\hat{ }4 |
| three years ago | level, DMA level, for past 25 model | 1000 | |
| to one day ago) | years | | |
| exo fits (MDD | exogenous parameters at model-- | <5 * | <5 * 10\hat{ }10 |
| level) | dealer--day level, for past 3 years | 10\hat{ }10 × | |
| | | 20 | |
| exo fits (DD | exogenous parameters at dealer-- | <5 * | <5 * 10\hat{ }7 |
| level) | day level, for past 3 years | 10\hat{ }7 × | |
| | | 20 | |
| stored model | ~20 model parameters columns for | 2 * 10\hat{ }7 × | 4 * 10\hat{ }8 |
| parameters | all pricing bins | 20 | |

The actual row counts shown above are rough estimates that may vary greatly depending on how trim groups and other data bins are defined. In practice, it may be reasonable to aggregate trim groups, model, years and individual dealers when the data is limited or most of the variation within an aggregation is determined to be a result of statistical noise. In such cases, the numbers in the above table may be taken as upper limits, particularly for exogenous inputs.

As shown by the illustrative table above, according to some embodiments, the sheer volume of raw data and processing required just to make the data ready for use (for example, by normalizing prices into PRs) are such that implementing a vehicle data system that returns responses to a client within the time frames expected by users of computer network based systems requires a level of computational performance far beyond that provided by conventional and known systems.

According to some embodiments of a vehicle data system, gains in performance over known systems may be enabled in part by an architecture with a back-end that provides pre-computation and storage of data (e.g., data bins), models and variables used in the generation of market trend predictions.

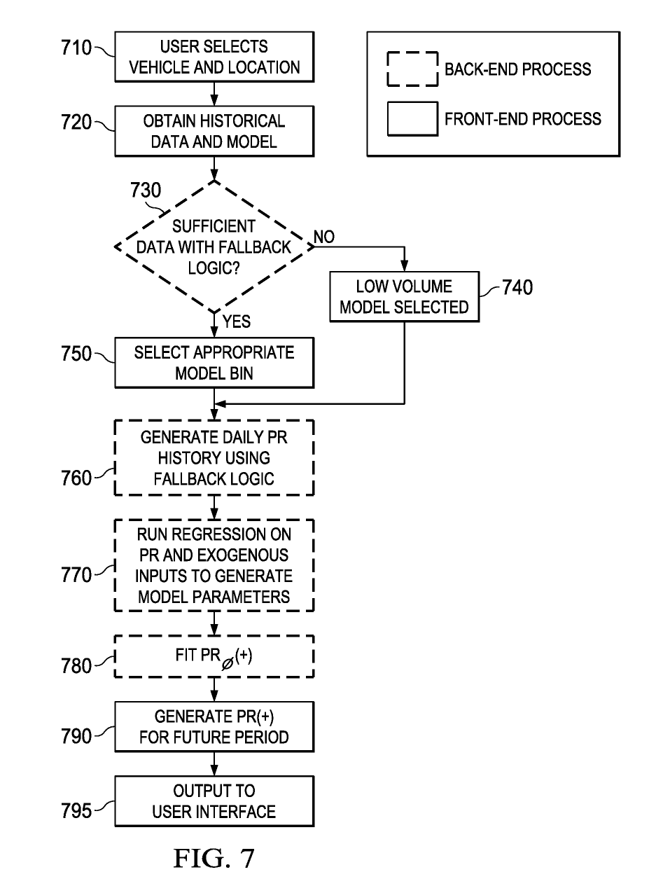

Turning to FIG. 7, a flow diagram for an embodiment of a method by which market trend forecasts may be provided to a user of a vehicle data system in real-time in a front-end process is depicted. In order to accomplish this real-time determination and presentation of market trend forecast, certain of these steps may utilize data, components or models determined in a back-end process. In FIG. 7, steps which may be performed as back-end processes are shown with dashed lines and steps customarily performed in the front-end are shown with solid lines. The method begins at step 710 when a user selects a vehicle trim, zip code and one or more time periods. At step 720 historical data (e.g., a bin of data) and one or more models or components thereof (e.g., model fits) may be obtained from a data store on the vehicle data system. The collection and binning of historical data may be carried out by a back-end process of the vehicle data system, including requesting or receiving transaction, market, incentive and other data on a one time or an ongoing basis, including as a scheduled process or in response to dealers and other data sources transmitting data to the vehicle data system. Similarly, the determination of models, including model fits, such as identifying the data bins with utilizing fallback binning logic, may also be performed in advance by back-end systems.

At step 730 a decision can be made if a bin of a set of bins associated with specified vehicle configuration contains a sufficient amount of data to utilize to generate a predictive model or a forecast using fallback binning logic as discussed above. The fallback binning logic and data sufficiency testing may be accomplished in a back-end process as discussed above (e.g., at any time between updates to the data underlying the data bins applied in the fallback binning logic). An appropriate model bin may be selected at step 750 if a bin can be found with sufficient data. The selected bin may be the most specific bin of the set of bins that contains sufficient data for the specified vehicle configuration. Otherwise a low volume model may be selected at step 740.

A daily PR history for the bin of data may be determined at step 760. The daily PR history for the bins of data associated with specified vehicle configuration and location may be determined in a back-end process of the vehicle data system (e.g., in advance of the user request received at step 710). The pre-calculation of PR may be done, for example, at any time between updates to the data set from which PR histories are calculated without any adverse effects on the accuracy of the generated values for PR(t).

Similarly, the linear or polynomial regressions, which, according to some embodiments, model near-term fluctuations in market price, the effects of exogenous variables, and the effect of structural/cyclical features of the vehicle market may be determined at step 770 and a fit for PR₀(t) determined at step 780. These determinations may also be performed as a back-end process by the vehicle data system. In this way, much of the computational load associated with quickly generating and providing market trend predictions over a network based interface may be accomplished as back-end processes. Finally, at step 795, an interface showing the determined PR prediction is output to a user. Moreover, further reducing computational load, these processes may be performed as back-end processes for all or certain (e.g., frequently selected) combinations of vehicle trim, date and location during periods of low usage of the vehicle data system.

Using the data and models a PR(t) for the user specified vehicle configuration, location and time period may be generated at step 790. The generation of PR(t) may thus occur in the front-end process of the vehicle data system in real-time, enabled by the models and components determined in the back-end processes. The generated PR(t) may then be used to generate an interface to output the market trend forecast in real-time to the user based on the generated PR(t). In this manner, a real-time market forecast may be returned in response to the user request received at step 710 utilizing the data, models and components obtained and determined in the back-end processes of the vehicle data system.

Skilled artisans will realize that the foregoing description of processes which may be carried out in the back-end is merely illustrative, and that other possibilities within the spirit of the invention are possible. Depending on market conditions and the current and expected load on the vehicle data system, the degree to which processes are performed at the back-end may change upwards or downwards.

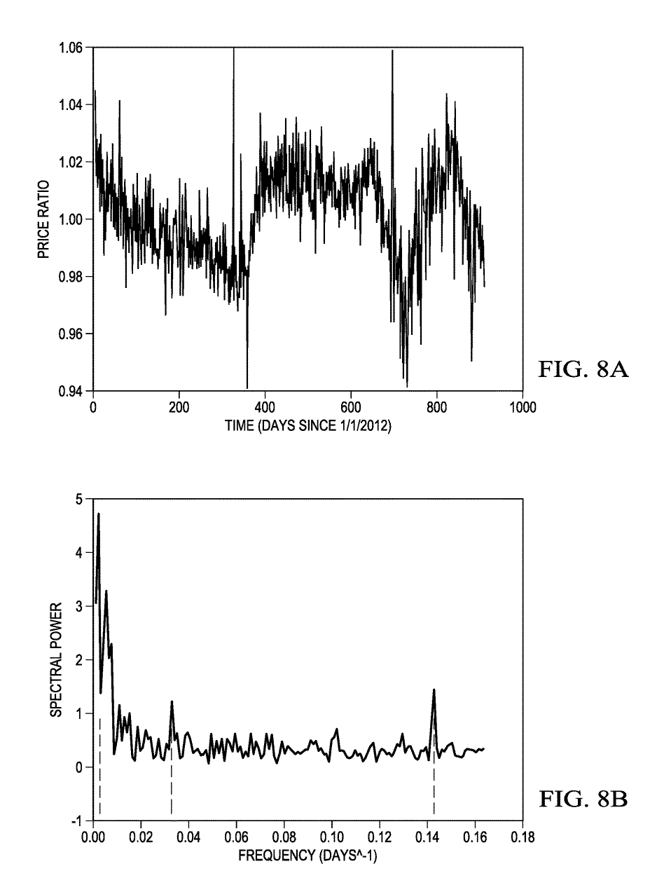

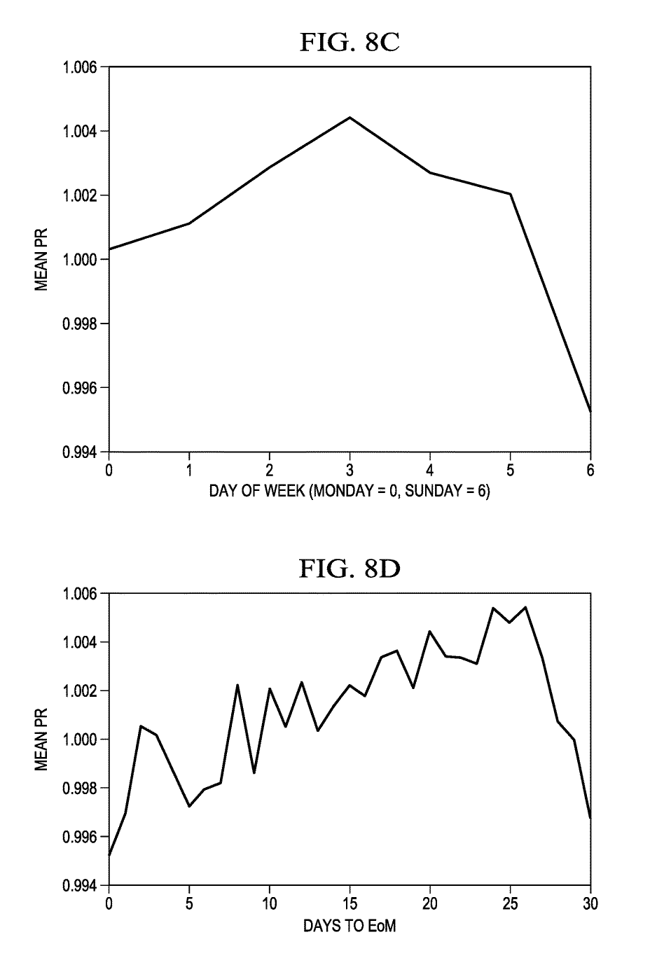

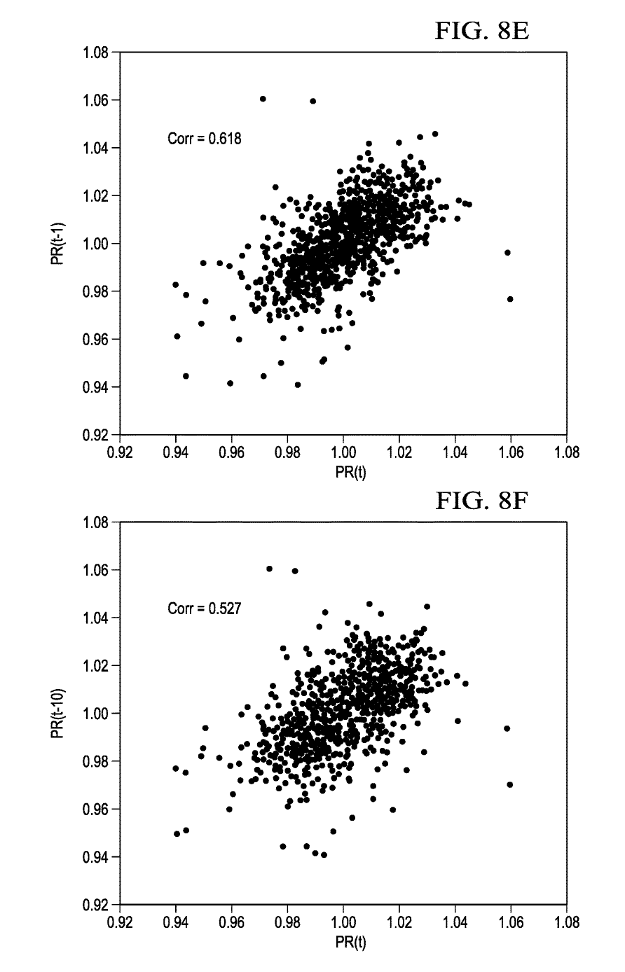

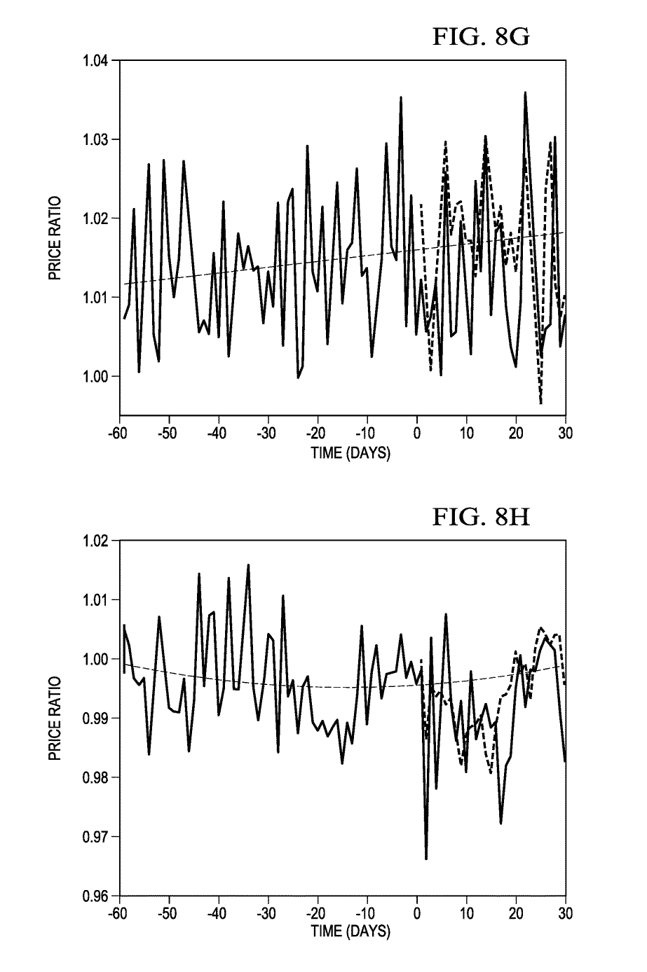

Examples of determination of data or models with respect to a particular vehicle may be useful for an understanding of embodiments as disclosed. Accordingly, FIGS. 8A-8H depict graphics useful in the sample walkthrough of a construction of a model such as those by embodiments of a vehicle data system. In this example, a Honda Civic Sedan is selected as the vehicle trim group of interest. Additionally, in this example, a user has indicated that the market forecast for the selected vehicle be calculated at the national level, without regard for geographical fluctuations in the market price at the regional, state or dealer market area level.

In this example, the vehicle data system applies fallback binning logic to identify from within the universe of historical transaction data and determined data, data from which a prediction of the market price for a given data may be made. In this example, the data store contains a large number of transactions involving the Honda Civic Sedan, with a median number of nationwide transactions/day of 56 and the 5^{th} percentile of sales per day is 23. In this case, the abundance of data for a relatively popular vehicle over a large geographical extent means that the fallback binning logic uses the first bin, which has the narrowest structural and temporal extent.

FIG. 8A shows a plot of observed daily PR data for the Honda Civic Sedan over an approximately two year period beginning on Jan. 1, 2012. Price Ratio (PR) is shown on the y-axis and time is shown on the x-axis. In FIG. 8A, trends in price ratio from seasonality and model year cycle can be seen, as well as large single-day changes, which may often be related to holidays.

FIG. 8B shows a spectral plot obtained by performing a Fast Fourier Transform (FFT) of the daily PR data shown in FIG. 8A. In FIG. 8B, the x-axis represents a spectrum of frequencies (expressed as dayŝ−1) found in the FFT of the data of FIG. 8A, and the y-axis represents spectral power, which is a measure of the extent to which a particular frequency contributes to the plot, or signal, shown in FIG. 8A. In this case, FIG. 8B shows spikes at frequencies f=0.03333 (e.g., ˜1/30 days) and f=0.143 (e.g., ˜1/7 days) indicating that the fluctuation in daily PR has strong features with weekly and monthly timescales.

The contribution of periodic effects having weekly or monthly timescales is further shown by FIGS. 8C and 8D. FIG. 8C shows a plot of stacked results for PR averages as a function of day of the week. In this figure, the x-axis shows mean PR, and the y-axis represents the day of the week, expressed as the number of days from Monday. FIG. 8C shows a clear rise and fall in the mean PR over the course of the week, peaking on Thursdays and crashing on Sundays.

FIG. 8D shows a plot of stacked PR averages over a monthly period. Mean PR is shown on the y-axis, and time, expressed as days until the end of the month are shown on the x-axis. Again, in the case of the Honda Civic Sedan, there is a clear monthly trend, with the PR decreasing drifting downwards over the course of the month.

FIGS. 8E and 8F provide scatterplots of pairings of PR for the Honda Civic Sedan at one day intervals (FIG. 8E) and ten day intervals (FIG. 8F). In both FIGS. 8E and 8F, the PR value for the later day PR(t) is shown on the x-axis and the PR value for the previous, or in the case of FIG. 8F, ten days earlier, day are shown on the y-axis. In the case of the Honda Civic Sedan, there is a stronger correlation between daily PR values, as FIG. 8E shows a correlation coefficient of 0.618, than for temporally distant days, as FIG. 8F shows a correlation coefficient of 0.527.

Having established that daily PR values fluctuate noisily, but at the same time, exhibit periodic and foreseeable variance structures, attention is now turned to FIGS. 8G and 8H, which demonstrate the predictive performance of one embodiment of the vehicle data system as implemented.

FIG. 8G presents a plot of the fluctuations in daily PR for the Honda Civic Sedan over a randomly selected 90 day period in the historical data set. In FIG. 8G, actual PR values are plotted as a solid line. The y-axis represents price ratio, and the x-axis shows time expressed relative to t=0, or the start of the predictive period. In this case, times t=−60 to t=0 comprise the historical period over which a baseline value for PR₀(t) is determined. In the example of FIG. 8G, PR₀(t) is modeled as a first order polynomial regression over times t=−60 to t=0. PR₀(t) is shown in FIG. 8G as a dotted line. In the example of FIG. 8G, near-term fluctuations are modeled based on an autoregression over the five days prior to t=0. In FIG. 8G, a dashed line shows the predicted values of PR(t) by applying near-term corrections, corrections for exogenous variables and corrections for structural/cyclical effects.

FIG. 8H likewise presents a plot of the fluctuations in daily PR for the Honda Civic Sedan over a randomly selected 90 day period in the historical data set. In FIG. 8G, actual PR values are plotted as a solid line. The y-axis represents price ratio, and the x-axis shows time expressed relative to t=0, or the start of the predictive period. In this case, times t=−60 to t=0 comprise the historical period over which a baseline value for PR₀(t) is determined. In the example of FIG. 8G, PR₀(t) is modeled as a second order polynomial regression over times t=−60 to t=0. PR₀(t) is shown in FIG. 8H as a dotted curve. In the example of FIG. 8H, near-term fluctuations are modeled based on an autoregression over the five days prior to t=0. In FIG. 8H, a dashed line shows the predicted values of PR(t) by applying near-term corrections, corrections for exogenous variables and corrections for structural/cyclical effects.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. For example, it will be understood that while embodiments as discussed herein are presented in the context of a browser based application other embodiments may be applied with equal efficacy to other types of components on computing device (e.g., other native components, etc.).

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented programming. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A vehicle data system for providing accurate vehicle data in real-time over a computer network, comprising:
a data store; and
a plurality of computing devices coupled to one another, one or more user computing devices, and a plurality of online data sources, over a network, wherein:
a first computer device of the vehicle data system performs a back-end process including:
obtaining historical transaction data on a plurality of vehicles from the plurality of online data sources;
segmenting the historical transaction data into a plurality of bins based on vehicle configuration, location and time;
determining a price ratio for each of the plurality of bins, based on the historical transaction data in that bin;
determining a predictor for each of the plurality of bins based on the price ratio determined for that bin and the historical transaction data associated with that bin, wherein the predictor includes a predictive price ratio model and one or more adjustment components; and
a second computer device of the vehicle data system performs a front-end process operating distinctly from the back-end process to respond to requests received over the network via an interface module using the predictor and the plurality of bins of historical transaction data determined in the back-end process by:
receiving a request for a prediction of a future market price of a vehicle, the request specifying a vehicle configuration, a location and a future time period;
identifying a bin of historical data determined by the front-end process based on the specified vehicle configuration and location;
obtaining the historical data associated with the identified bin from the data store;
obtaining the predictor and one or more adjustment components for the identified bin determined by the front-end process;
determining a predicted price ratio for the specified future time period based on the predictive price ratio model associated with the identified bin;
adjusting the predicted price ratio using the one or more adjustment components of the predictor associated with the identified bin;
generating an interface providing a visual representation of a predicted market price over the specified time period based on the adjusted predicted price ratio; and
responding to the request in real-time over the network by distributing the generated interface over the network via the interface module.

2. The system of claim 1, wherein the system is configured to limit the magnitude of the adjustment by the one or more adjustment components using one or more guardrail values.

3. The system of claim 1, wherein the set of bins are ordered according to one or more parameters and identifying the bin comprises selecting a most specific bin with a threshold amount of historical transaction data.

4. The system of claim 3, wherein the interface comprises a localized curve based on the predicted price ratio associated with the specified location as a function of the time period.

5. The system of claim 4, wherein the predicted price ratio can pertain to the Designated Market Area (DMA), region or state associated with the specified location.

6. The system of claim 1, wherein the interface comprises a national curve based on the predicted price ratio associated with a nationwide location for the specified vehicle as a function of the time period.

7. The system of claim 1, wherein the interface comprises a historical data curve including historical pricing data for the specified vehicle configuration over a past time period associated with the specified location, wherein the historical data curve was determined based on the historical transaction data associated with the identified bin.

8. The system of claim 1, wherein the predicted market price is a transaction price or an upfront price.

9. The system of claim 1, wherein the one or more adjustment components include a first adjustment component configured to adjust the predicted price ratio on a historical derivation, a second adjustment component configured to adjust the predicted price ratio based on one or more exogenous parameter and a third adjustment component configured to adjust the predicted price ratio based on a status of a day.

10. The system of claim 9, wherein the at least one exogenous parameter is a dealer incentive, a customer incentive, a transportation costs or advertising and wherein a status of a day includes a day of the week, a day of the month or a holiday.

11. A method for providing accurate vehicle data in real-time over a computer network, comprising:
at a first computer device of a vehicle data system performing a back-end process:
obtaining historical transaction data on a plurality of vehicles from the plurality of online data sources;
segmenting the historical transaction data into a plurality of bins based on vehicle configuration, location and time;
determining a price ratio for each of the plurality of bins, based on the historical transaction data in that bin;
determining a predictor for each of the plurality of bins based on the price ratio determined for that bin and the historical transaction data associated with that bin, wherein the predictor includes a predictive price ratio model and one or more adjustment components; and
at a second computer device of the vehicle data system performing a front-end process operating distinctly from the back-end process to respond to requests received over the network via an interface module using the predictor and the plurality of bins of historical transaction data determined in the back-end process:
receiving a request for a prediction of a future market price of a vehicle, the request specifying a vehicle configuration, a location and a future time period;
identifying a bin of historical data determined by the front-end process based on the specified vehicle configuration and location;
obtaining the historical data associated with the identified bin from the data store;
obtaining the predictor and one or more adjustment components for the identified bin determined by the front-end process;
determining a predicted price ratio for the specified future time period based on the predictive price ratio model associated with the identified bin;
adjusting the predicted price ratio using the one or more adjustment components of the predictor associated with the identified bin;
generating an interface providing a visual representation of a predicted market price over the specified time period based on the adjusted predicted price ratio; and
responding to the request in real-time over the network by distributing the generated interface over the network via the interface module.

12. The method of claim 11, wherein the system is configured to limit the magnitude of the adjustment by the one or more adjustment components using one or more guardrail values.

13. The method of claim 11, wherein the set of bins are ordered according to one or more parameters and identifying the bin comprises selecting a most specific bin with a threshold amount of historical transaction data.

14. The method of claim 13, wherein the interface comprises a localized curve based on the predicted price ratio associated with the specified location as a function of the time period.

15. The method of claim 14, wherein the predicted price ratio can pertain to the Designated Market Area (DMA), region or state associated with the specified location.

16. The method of claim 11, wherein the interface comprises a national curve based on the predicted price ratio associated with a nationwide location for the specified vehicle as a function of the time period.

17. The method of claim 11, wherein the interface comprises a historical data curve including historical pricing data for the specified vehicle configuration over a past time period associated with the specified location, wherein the historical data curve was determined based on the historical transaction data associated with the identified bin.

18. The method of claim 11, wherein the predicted market price is a transaction price or an upfront price.

19. The method of claim 11, wherein the one or more adjustment components include a first adjustment component configured to adjust the predicted price ratio on a historical derivation, a second adjustment component configured to adjust the predicted price ratio based on one or more exogenous parameter and a third adjustment component configured to adjust the predicted price ratio based on a status of a day.

20. The method of claim 19, wherein the at least one exogenous parameter is a dealer incentive, a customer incentive, a transportation costs or advertising and wherein a status of a day includes a day of the week, a day of the month or a holiday.
